(19) United States
(12) Patent Application Publication
(10) Pub. No.: US 2015/0356281 A1
(43) Pub. Date: Dec. 10, 2015

(54) Secure Watermarking of Content

(71) Applicants: NEDERLANDSE ORGANISATIE VOOR TOEGEPAST- NATUURWETENSCHAPPELIJK ONDERZOEK TNO, s'-Gravenhage (NL); KONINKLIJKE KPN N.V., The Hague (NL)

(72) Inventors: Mattijs Oskar Van Deventer, Leidschendam (NL); Peter Veugen, Voorburg (NL)

(73) Assignees: Koninklijke KPN N.V., The Hague (NL); Nederlandse Organisatie voor Toegepast- Natuurwetenschappelijk Onderzoek TNO, s'-Gravenhage (NL)

(21) Appl. No.: 14/655,455

(22) PCT Filed: Dec. 30, 2013
(86) PCT No.: PCT/EP2013/078120

§ 371 Date: Jun. 25, 2015

(30) Foreign Application Priority Data
Dec. 28, 2012 (EP) 12199593.0

(51) Int. Cl. G06F 21/16; H04L 9/00

(52) U.S. Cl. CPC G06F 21/16; H04L 9/008; G06F 2221/0737

(57) ABSTRACT

Methods and systems for secure watermarking of at least part of a content item X are described, wherein the method comprises: providing a distorted content item X+y, comprising one or more distorted data units wherein the payload of a distorted data unit comprises a distortion signal y which distorts the rendering of the payload in said distorted data unit; providing a compensating watermark payload w-y comprising one or more compensating watermark signals S−y; using homomorphic encryption for en-crypting at least part of said distorted content item X−y and said compensating watermark payload into an encrypted distorted content item E(X+y) and an encrypted compensating watermark payload E(w-y) on the basis of one or more encryption keys; and, combining said encrypted distorted content item with said encrypted compensating watermark payload on the basis of one or more homomorphic computations, wherein said one or more computations modify a distortion signal y in the payload of a distorted data unit into a non-perceptible watermark signal S.

### FIELD OF THE INVENTION

The invention relates to secure watermarking of content and, in particular, though not exclusively, to methods for secure watermarking content, a data transmitter for enabling secure watermarking, a content processing entity for secure watermarking, a data structure for enabling secure watermarking and a computer program product using such method.

### BACKGROUND OF THE INVENTION

Content providers generate and offer content (e.g. content items in the form of video and/or music titles) to consumers and sometimes deliver it directly to consumers. Often however the delivery of the content to a consumer is outsourced to an intermediate party, a content distributor, which may comprise one or more content delivery networks (CDNs) for delivering content to customers. Currently CDNs are developed that allow cheap, efficient and high quality content delivery to a large number of consumers. When a CDN receives content items from a content source (i.e. a content source device such as a streaming server), the items are replicated and distributed over one or multiple delivery nodes of the CDN. Upon a request from a consumer, a content item is delivered from the nearest (or otherwise most suited) delivery node in the CDN.

The delivery of the content, and especially the delivery of content using a CDN or a network of CDNs, comprising multiple copies of content items, faces a substantial risk of unauthorized access to content (signal theft) and unauthorized (re)distribution of content (content theft). For example, a content item may be illegally copied, by using e.g. a high-definition camcorder or by decrypting illegally intercepted encrypted content. For that reason content protection systems like Digital Rights Management (DRM) and Conditional Access (CA) systems are used to reduce the risk of signal or content theft, and to allow only authorized consumers and systems accessing it.

Typically, a content protection system may use a combination of encryption and watermarking techniques. Encryption may be regarded as a measure against signal theft. By using encryption, the signal (containing the content) can only be read by consumers that have the key to decipher the content. Hence, even if the signal is illegally intercepted, the content is only accessible if it is decrypted.

Watermarking may be regarded as a measure against content theft. Invisible to the consumer, there can be one or multiple watermarks in the content item identifying for example: the content item itself , the content source, the content distributor, the buying consumer and/or a transaction. A watermark may generally relate to hidden information, usually digital information, in the one or more data units of a content item, typically a content file or stream. When rendered for display, the watermark is not perceptible or only perceptible under certain conditions. This way, a watermark can be used to test the authenticity (origin) of the content item and to trace unauthorized distribution of the content item. Usually the watermark may have the form of a sequence of bits, which may form a unique value for identification of a transaction (transaction identifier).

Watermarks may be designed so that they survive different signal processing and filtering techniques and so that it remains possible to trace an illegal copy of the content item back to its last authorized user, e.g. the consumer who bought the content, using a forensic tracing technique. Combining encryption and watermarking, especially in a CDN environment, poses considerable technological challenges, as it may require outsourcing of the watermarking process to a content receiving entity, e.g. a CDN or a client, wherein the content received by the content receiving entity is encrypted by the content source. Hence, a content receiving entity (i.e. a content receiving device) should be able to watermark content without decrypting it as the presence of a decryption and re-encryption process in the content receiving entity would introduce an undesirable loophole in the security scheme.

WO2006/129293 proposes a watermarking scheme wherein a server is configured to encrypt an audio signal (MP3) on the basis of a first key into an encrypted audio signal Cx and a watermark payload signal is encrypted on the basis of a second different key into an encrypted watermark payload signal Cw. Both signals are sent to a client which combines both encrypted signals on the basis of a homomorphic encryption function, which function is used to add both signals together in the encrypted domain, resulting in an encrypted watermarked audio signal Cx+w. Thereafter, the client may decrypt this signal into a watermarked audio signal using a third key. This scheme relies on a special additive homomorphic cryptosystem wherein two encrypted signals, which are encrypted using different encryption keys, first need to be combined before the (now watermarked) audio signal can be decrypted with a decryption key. This way a client is “forced” to add the watermark signal to the audio signal before it can be decrypted. This way an encryption/watermarking scheme is provided that is robust against manipulation of the watermarking process in an untrusted environment.

One problem related to the proposed watermarking scheme is that the additive homomorphic algorithm used in WO2006/129293, mandates every data unit in the encrypted audio signal to be combined with a data unit from the encrypted watermarking signal. The decryption key does not work on the encrypted (non-combined) audio signal. Hence due to the special properties of the specific additive homomorphic algorithm used, parts of the non-combined encrypted audio signal that are not combined with corresponding parts of the encrypted watermarking signal can simply not be decrypted and played-out. For this reason, the encrypted watermarking signal is of the same size as the encrypted audio signal. The proposed watermarking scheme therefore doubles the amount of data that is processed by the (encryption module in the) server, exchanged between the client and the server and processed by the client. While this may still be workable when using small (audio) files, such scheme is not suitable or far less suitable in situations that require encryption and watermarking of encoded, large compressed HD video streams (e.g. HDTV) that are streamed to a large number of clients. The additional network load in the network as a result of the large encrypted watermarking signals and the additional processor loads, both on the network side and the client side, related to the various signal encryption, addition, and decryption processes could be substantial.

A further (related) problem relates to the fact that the proposed scheme does not provide a scalable solution, when measures against content theft need to be taken as well . It is often desired that a watermarking signal is specific for that particular transaction so that each client will receive its own watermarked version of the audio file and so that a watermarked file can be traced back to the client that requested the audio file. In that case a different watermarking signal of the same size as the audio file needs to be generated each time a client requests an audio file from the server. Application of such scheme to a situation wherein high-density video streams are delivered to a large number of clients could easily lead to additional (on top of the encryption related processing load) watermaking type processing load of the server producing at every request a customized watermarking signal. Hence using such prior art scheme is prone to server overload and network congestion and delays when used in large-scale deployments such as commercial CDN's, and/or when additional measures against content theft need to be taken.

Thus, from the above it follows that the prior art does not provide a watermarking scheme for secure watermarking in the encrypted domain that is both scalable and robust against manipulation of the watermarking process. Hence, there is a need in the art for improved methods and systems, which enable efficient watermarking and secure delivery of watermarked and encrypted content to a large number of content consumption units.

### SUMMARY OF THE INVENTION

It is an object of the invention to reduce or eliminate at least one of the drawbacks known in the prior art and to provide in a first aspect of the invention a method for secure watermarking and delivery of at least part of a content item X, wherein said method may comprise: providing a distorted content item X+y, comprising one or more distorted data units, wherein the payload of a distorted data unit comprises a distortion signal y which distorts the rendering of the payload in said distorted data unit; providing a compensating watermark payload w-y comprising one or more compensating watermark signals δ−y; using homomorphic encryption for encrypting at least part of said distorted content item X+y into an encrypted distorted content item E(X+y), and for encrypting at least part of said compensating watermark payload into an encrypted compensating watermark payload E(w-y) on the basis of one or more encryption keys; and, combining at least part of said encrypted distorted content item E(X+y) comprising said one or more distorted data units with at least part of said encrypted compensating watermark payload E(w-y) on the basis of one or more homomorphic computations, wherein said one or more computations modify a distortion signal y in the payload of a distorted data unit into a, preferably non-perceptible, watermark signal δ.

Hence, by combining the payload of distorted data units (which would produce a distorted video signal when rendered as a result of the distortion signal y) with compensating signals (which comprise a compensation signal −y for compensating the distortion signal +y and which may optionally comprise a watermarking signal δ) in the encrypted domain, at least some of the distorted data units are transformed in perturbed data units, wherein the original distortion signal +y is no longer present and wherein the watermarking signals in the payload of these data units form a watermark that may be detectable using forensic techniques. The watermarking technique according to the invention is secure as the actual watermarking is performed in the encrypted domain, which is possible through the use of homomorphic encryption. The watermarking technique according to the invention furthermore forces a content receiving entity such as a content consumption unit (CCU) or a content distributor (e.g. a CDN) to combine the compensating signals with the distorted data units, since rendering the distorted data units as such would produce a distorted video (or audio) signal, making it unsuitable for practical purposes. This way manipulation of the watermarking process may be substantially reduced. As only a limited number of data units need to be distorted, the size of the encrypted compensating signals that need to be sent to the content receiving entity responsible for the watermarking (e.g a CCU or CDN) will be small, thereby making the technique suitable for (HD) video streaming techniques in large scale commercial deployments such as CDN's. Moreover, the small size of the encrypted compensating signals further facilitates different watermarking of a content item for different clients.

In an embodiment, providing said distorted content item may comprise providing distortion position information, wherein said distorting position information may comprise: information for identifying the position of distorted data units in said distorted content item; information for identifying a predetermined distortion signal yᵢ that is added to a distorted data unit at a predetermined position in said distorted content item; and, information for identifying which of said distorted data units are perturbable. A perturbable data unit may comprise a payload that is suitable for receiving one or more watermark signals δᵢ.

In these embodiments, distortion position information may be generated (by a content processing entity (also referred to as a content processing device), e.g. a content source (i.e. a content source device, which is a device providing the content over a transmission medium such as a wireless/wireline network to another device)) wherein the distortion position information may identify which data units are distorted and which of the distorted data units are perturbable (i.e. suitable for embedding a watermarking signal that is not perceptible to the consumer under ordinary circumstances when rendered). Identification of perturbable data units may be necessary when the payload of a data unit is very sensitive for small alterations such as the addition of a (small) watermarking signal. For example, the payload of data units may be encoded using entropy encoding which is very sensitive to small alterations in the information so that the addition of a small watermarking signal to an encoded payload may have—in some cases—a large impact on how the content associated with the payload is eventually displayed. Therefore, only certain predetermined data units (referred to as perturbable data units), which have a payload that allows insertion of a perturbation (without being perceptible to the consumer when rendered), are selected for embedding a watermark signal δᵢ.

In another embodiment, providing said compensating watermark payload may comprise forming a compensating watermarking signal on the basis of said distortion position information and one or more distortion signals yᵢ in said distortion position information. A watermarking generator may use the distortion position information to identify the position of a distorted (and preferably perturbable) data unit and to identify the distortion signal yᵢ in the distorted data unit so that it may generate a watermarking compensating signal for the distorted (and preferably perturbable) data unit.

In an embodiment providing said distorted content item may comprise providing watermarking position information, wherein said watermarking position information may comprise information for identifying a compensating watermark signal in said encrypted compensating watermark payload. In another embodiment, said compensating watermark signal may comprise information for relating said compensating watermark signal to a position of a distorted data unit in said encrypted distorted content item. In this embodiment, watermarking position information may be used for combining (embedding) the encrypted compensating watermark payload with (in) the encrypted distorted content item using a homomophic computation. In particular, watermarking position information may be used for combining a predetermined distorted data unit xᵢ+yᵢ at a predetermined position in the distorted content item with its associated compensating watermarking signal δᵢ−yᵢ or −yᵢ such that the distortion signal yᵢ is compensated and such that (in case of a distorted perturbable data unit) a perturbation signal δᵢ is added. Once embedded, such perturbation signal is to be understood as a, preferably non-perceptible, part of a watermark.

In a further embodiment the payload of a perturbable data unit may comprise encoded data. In yet further embodiment said payload may comprise MPEG or H.264-encoded data. In an embodiment, said encoded data may comprise one or more (low frequency) DCT coefficients. In another embodiment said one or more compensating watermark signals may be combined in the encrypted domain with one or more distorted DCT coefficients in the payload of one or more distorted data units. In yet another embodiment, said one or more compensating watermark signals may be combined in the encrypted domain with one or more distorted low frequency DCT coefficients in the payload of one or more distorted data units. Hence, the invention allows the introduction of watermarking signals in the encoded distorted payload of a distorted data unit on the basis of one or more homomorphic computations.

In an embodiment forming said compensating watermark payload may comprise: generating a watermark payload w on the basis of an identifier, said watermark payload comprising one or more watermark signals δ; providing said compensating watermark payload w-y on the basis of said watermark payload w and said one or more distortion signals y. In a further embodiment, said method may comprise: a client in a content consumption unit requesting a content item; in response to said request of said client, said content source generating said compensating watermark payload w-y on the basis of an (unique) identifier, preferably a transaction identifier associated with said client and/or content item;

When a user requests the delivery of a content item from the content source, a transaction identifier ID may be generated on the basis of the user or client identity, the content source identity, type of transaction, date and time of the transaction, etc. The watermark generator may then generate a “personalized” watermark payload w comprising a predetermined number of perturbation signals δ on the basis of the transaction identifier ID. Hence, the invention allows to generate a particular watermark payload and the embedding of the watermark payload in a content item, wherein the watermark is linked to the requesting client, the requested content item, the content source and/or the content distributor.

In an embodiment, said method may comprise: a content consumption unit receiving said encrypted distorted content item E(X+y) and said encrypted compensating watermark payload E(w-y) from a content source; a watermark embedder in said content consumption unit combining at least part of said encrypted distorted content item with at least part of said encrypted compensating watermark payload E(w-y) on the basis of one or more homomorphic computations into an encrypted watermarked content item. Because of the distortion information in the distorted content item, the content consumption device is forced to compensate the distortion information with the compensating watermark payload thereby automatically watermarking the content. This way, the invention allows secure and controlled watermarking by a third party (in this case the content consumption unit) in accordance with the specifications as provided with the content source (e.g. content provider).

In an embodiment, said method may further comprise: a decryption unit in said content consumption unit comprising decrypting said encrypted watermarked content item into a watermarked content item on the basis of at least one decryption key d.

In an embodiment, said method may further comprise: a content distributor, preferably a content delivery network (CDN), receiving said encrypted distorted content item E(X+y) and said encrypted compensating watermark payload E(w-y) from a content source (i.e. a content source device); a watermark embedder in said content distributor combining at least part of said encrypted distorted content item with at least part of said encrypted compensating watermark payload on the basis of one or more homomorphic computations into an encrypted watermarked content item E(X+w). In an embodiment, said method may comprise: a content consumption unit receiving said encrypted watermarked content item from said content distributor; a decryption unit in said content consumption unit decrypting said encrypted watermarked content item into an watermarked content item using at least one decryption key.

In an embodiment said homomorphic encryption may be based on a homomorphic cryptosystem comprising at least one encryption algorithm E, at least one decryption algorithm D and a key generator for generating at least an encryption key e and a decryption key d for use with said encryption algorithm D and decryption algorithm E respectively, preferably said homomorphic cryptosystem being based on the RSA, the El Gamal, the Damgard-Jurik or the Pallier encryption and decryption algorithms. The watermarking scheme according to the present invention may be used with many well-known (conventional) homomorphic cryptosystems.

In an embodiment, said homomorphic encryption may be based on a split-key cryptosystem wherein said split-key cryptosystem may comprise encryption and decryption algorithms E and D, a key generation algorithm for generating encryption and decryption keys e,d, a split-key algorithm for splitting e into i different split-encryption keys and/or for splitting d into k different split-decryption keys d₁,d₂, . . . , dₖ respectively wherein i,k≧1 and i+k>2; wherein when using said split-key cryptosystem executing i consecutive encryption operations and k consecutive decryption operations on content item X using said split-encryption and split-decryption keys respectively, generates a fully decrypted content item X: D_{dk}(D_{dk-1}( . . . (D_{d2}(D_{d1}(Eₑᵢ(Eₑᵢ₋₁( . . . (Eₑ₂(Eₑᵢ(X)) . . . ))=X.

The split-key cryptosystem allows a content source (such as a content provider) to (partially) encrypt a distorted content item only once using the encryption algorithm E and a (split-) encryption key before it is sent to the content distributor, which will store the (partially) encrypted content item and one or more perturbations for future use. Thereafter, during subsequent distribution of content items by the content distributor to requesting CCUs, the watermarking process (and in some embodiments some of the further crypto operations) are executed in the encrypted domain using one or more homomorphic computations, wherein for each request different sets of split-encryption and/or split-decryption keys may be generated so for each request a differently encrypted and watermarked content item may be delivered to the requesting client. This way, secure outsourcing of watermarking to a content distributor (an intermediate party) and the provisioning of differently (uniquely) encrypted and differently (uniquely) watermarked content items to a large number of different CCUs may be achieved. The outsourcing of the watermarking process to the content distributor allows substantial reduction of processing load of the content source and substantial reduction of data traffic between the content source and the content distributor.

In an embodiment, said split-key cryptosystem may be based on the homomorphic Damgard-Jurik (DJ) encryption and decryption algorithms. In an embodiment said split-key cryptosystem may comprise a split-key algorithm for executing the steps of: determining an integer d₂ to be a random number d₂ ∈ {0, . . ., n−1} wherein n is the modulus of the DJ system; determining d₁ by calculating (d−d₂) mod n;

In an embodiment, said split-key cryptosystem is based on the homomorphic RSA encryption and decryption algorithms. In an embodiment, said split-key cryptosystem may comprise a split-key algorithm for executing the steps of: determining an integer d₁ to be a random number 1<d₁<φ(n), wherein d₁ and φ(n) are coprime, n is the modulus of the RSJ system, and φ(n) is Euler's totient function; determining d₂=d₁⁻¹*d(mod φ(n)).

In an embodiment, said split-key cryptosystem may be based on the homomorphic El Gamal encryption and decryption algorithms. In an embodiment, said split-key cryptosystem may comprise a split-key algorithm for executing the steps of: determining an integer d₁ to be a random number d₁ ∈ {1, . . ., p−2}; determine d₂=(d−d₁) mod p.

In an embodiment, said method may comprise: a decryption unit in said content distributor partially decrypting said encrypted watermarked content item using a first split-decryption key dl thereby forming a partially encrypted watermarked content item; a decryption unit in said content consumption unit fully decrypting said partially encrypted watermarked content item using a second split-decryption key d2.

In an embodiment, combining said encrypted distorted content item with said encrypted compensating watermark payload may be performed by a first content delivery network. In an embodiment, said first content delivery network may comprise at least a watermark embedder configured for forming an encrypted watermarked content item by combining at least part of said encrypted distorted content item with at least part of said encrypted compensating watermark payload on the basis of one or more homomorphic computations. In an embodiment, providing a distorted content item X+y is performed by a content source. In an embodiment, said content source may comprise a processing function for generating a distorted content item X+y on the basis of at least part of said content item X and one or more distortion signals y.

In an embodiment said delivery of at least part of said content item may comprise sending at least part of said encrypted watermarked content item from a first (upstream) content distribution network (CDN1) to at a second (downstream) content distribution network (CDN2). In an embodiment, said first and second content distribution network may comprise at least an encryption unit comprising an homomorphic encryption algorithm and/or a decryption unit comprising an homomorphic decryption algorithm, wherein said homomorphic encryption and decryption unit being associated with a homomorphic cryptosystem. In an embodiment, said first and/or second content delivery network may comprise a watermark embedder for forming an encrypted watermarked content item by combining at least part of said homomorphic encrypted distorted content item with at least part of said homomorphic encrypted compensating watermark payload on the basis of one or more homomorphic computations. In an embodiment, said first CDN and second CDN may be configured to communicate over an interface, preferably an inter-CDN interface

In an embodiment, said method may comprise: said first CDN sending watermarking information over said interface to said second CDN, wherein said watermarking information may comprise: at least part of an (encrypted) compensating watermark payload, watermarking position information associated with a distorted content item, information on the type of cryptosystem used, a seed for generating one or more encryption keys and/or a watermarking policy.

Hence, in these CDN-based embodiments, a distorted content item and an associated compensating watermark payload may be sent in encrypted form to a first CDN1, which processes the distorted content item on the basis of a first part of the compensating watermark payload (e.g. inserts the first part of the compensating watermark payload w₁-y₁ in a first part of the distorted content item on the basis of the watermarking position information) and subsequently forwards the encrypted watermarked distorted content item and the encrypted compensating watermark payload to a second CDN2, which processes the encrypted watermarked distorted content item on the basis of a second part of the compensating watermark payload (e.g. inserts a second part of the compensating watermark payload w₂-y₂ in a second part of the watermarked distorted content item on the basis of the watermarking position information). A CDN may be configured to send perturbations to another CDNs in advance over an inter-CDN interface. This interface may also be used by CDNs to exchange information on the watermarking and encryption process.

In a further aspect, the invention may relate to a content source configured for enabling secure watermarking of a content item X. Said content source may comprise at least: a content processor for generating distorted content item X+y on the basis of at least part of said content item X and one or more distortion signals, said distorted content item comprising one or more distorted data units wherein the payload of a distorted data unit comprises a distortion signal y which distorts the rendering of the payload in said distorted data unit;a watermark generator for generating a compensating watermark payload w-y comprising one or more compensating watermark signals δ−y; an encryption unit for homomorphic encryption for encrypting at least part of said distorted content item X+y and said compensating watermark payload into an encrypted distorted content item E(X+y) and an encrypted compensating watermark payload E(w-y) on the basis of one or more encryption keys; and/or, a transmitter for sending said encrypted distorted content item and said encrypted compensating watermark payload to a watermark embedder configured for combining said encrypted distorted content item with said encrypted compensating watermark payload on the basis of one or more homomorphic computations, wherein said one or more computations modify a distortion signal y in the payload of a distorted data unit into a non-perceptible watermark signal δ.

In another aspect, the invention may relate to a content processing entity (i.e. a content processing device), preferably a content distributor or a content consumption unit, configured for secure watermarking a content item X. Said content processing entity may comprise at least one of: a data receiver for receiving at least part of an encrypted distorted content item, said distorted content item comprising one or more distorted data units wherein the payload of a distorted data unit comprises a distortion signal y which distorts the rendering of the payload in said distorted data unit; and for receiving a compensating watermark payload w-y comprising one or more compensating watermark signals δ−y; wherein said distorted content item and said compensating watermark payload are encrypted using a homomorphic encryption algorithm; a watermark embedder for forming an encrypted watermarked content item by combining said encrypted distorted content item with said encrypted compensating watermark payload on the basis of one or more homomorphic computations, wherein said one or more computations modify a distortion signal y in the payload of a distorted data unit into a non-perceptible watermark signal δ.

In an embodiment, said content processing entity may further comprise: a decryption unit in for decrypting said encrypted watermarked content item into a fully decrypted watermarked content item on the basis of at least decryption key; or, for partially decrypting said encrypted watermarked content item into a partially decrypted watermarked content item on the basis of at least split-decryption key.

In another aspect, the invention may relate to a data structure, preferably at least part of a manifest file, for use by a client in a content receiving entity, wherein said client may be configured to request and receive segments from at least one server on the basis of said manifest file, said segments comprising one or more homomophic encrypted distorted segments, said homomorphic encrypted distorted segments comprising one or more distorted data units, the payload of a distorted data unit comprising at least one distortion signal y; wherein said client may be further configured to combine at least one of said one or more distorted data units with at least part of a homomorphic encrypted compensating watermark payload on the basis of one or more homomorphic computations, wherein said one or more computations modify a distortion signal y in the payload of a distorted data unit into a, preferably non-perceptible, watermark signal δ, wherein said data structure enables said client secure watermarking of said content item; and, wherein said data structure may comprise: one or more segment identifiers and segment play-out information; watermarking position information for identifying compensating watermark signals in said encrypted compensating watermark payload and for relating said compensating watermark signals to a position of a distorted data unit in said encrypted distorted segment.

In an embodiment, the watermarking position information may comprise watermark bitrange information defining a bitrange (a set of bits) within an encrypted segment, wherein said bitrange may comprise one or more distorted data units.

The manifest file may comprise further information for the receiver. In an embodiment, the manifest file may further comprise (at least part of) the encrypted compensating watermark signals. In another embodiment, the manifest file may comprise a parameter for indicating the type of homomorphic encryption the watermarking system is using. In yet another embodiment, the manifest file may comprise a parameter for indicating the block size N used by the homomorphic cryptosystem.

The invention may also relate to a computer program product comprising software code portions configured for, when run in the memory of a computer executing at least one of the method steps as described above.

As will be appreciated by one skilled in the art, aspects of the present invention may be embodied as a system, method or computer program product. Accordingly, aspects of the present invention may take the form of an entirely hardware embodiment (e.g. as a microprocessor and/or circuitry), an entirely software embodiment (including firmware, resident software, micro-code, etc.) or an embodiment combining software and hardware aspects that may all generally be referred to herein as a “circuit,” “module” , “entity” “node” “client” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the users computer, as a stand-alone software package, partly on the users computer and partly on a remote computer, or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1A-1C depict schematics of a content delivery system for secure watermarking according to various embodiments of the invention.

FIG. 2 depicts a schematic of content delivery system for secure watermarking according to another embodiment of the invention.

FIG. 3 depicts a schematic of a content delivery system for secure watermarking according to a further embodiment of the invention.

FIG. 4 depicts a schematic of a content delivery system for secure watermarking according to yet a further embodiment of the invention.

FIG. 5 depicts a schematic of a secret key generator for use in a split-key cryptosystem according to one embodiment of the invention.

FIG. 6 depicts a schematic of a watermarking-block according to an embodiment of the invention.

FIG. 7 depicts a schematic overview of a content delivery system for secure watermarking according to an embodiment of the invention.

FIG. 8 depicts a process flow for secure watermarking a content item according to an embodiment of the invention.

FIG. 9 depicts a manifest file for enabling secure watermarking according to an embodiment of the invention.

### DETAILED DESCRIPTION

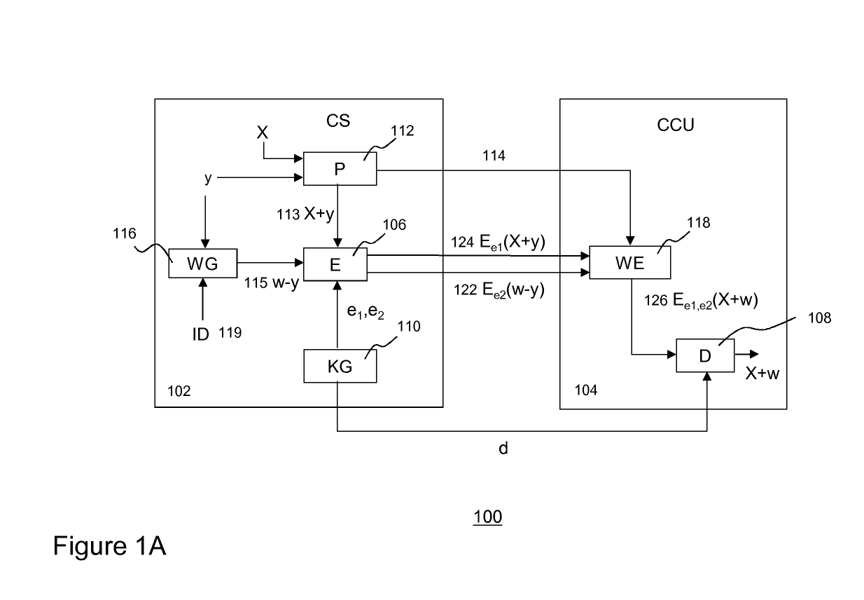

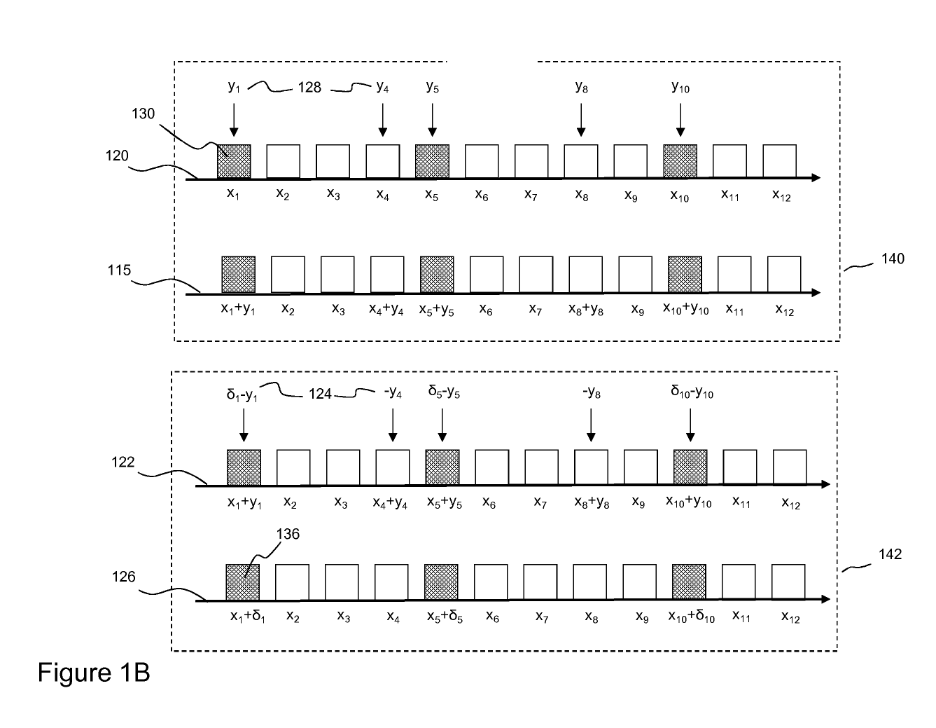

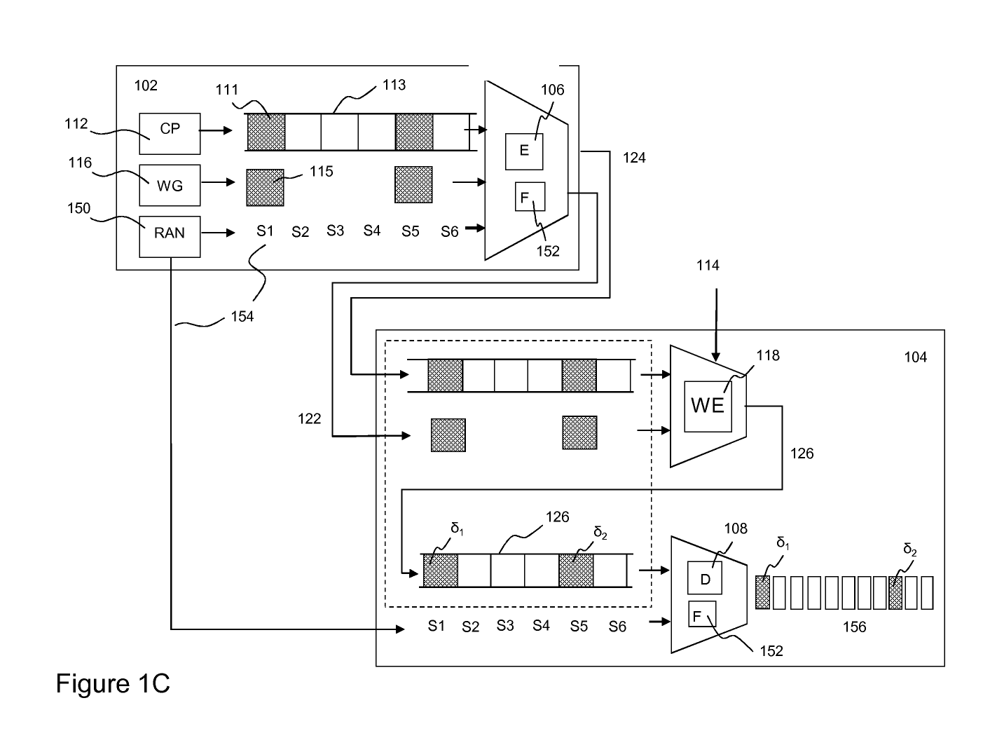

FIG. 1A depicts a schematic of a content delivery system according to an embodiment of the invention. In particular, FIG. 1A depicts a content delivery system 100 comprising a content source 102, (CS), e.g. an (HTTP) media server, configured for delivering content items to at least one content consumption unit (CCU) 104. Here, a content item may generally relate to (part of) a file or a stream comprising data units carrying a video, audio and/or text payload, wherein a data unit represents a logical data structure which may be determined by the one or more protocols which are used in delivering a content item to a CCU.

The content source, sometimes also referred to as the content originator, may comprise a content provider (CP), a content preparation system and/or a content distribution network (CDN). A content source may comprise one or more network nodes, e.g. one or more media servers, configured to offer and/or deliver content items, including but not limited to video, pictures, audio, software, data and/or text in the form of files and/or streams to consumers or another content distributor. A consumer may purchase and receive the content items using a content consumption unit (CCU), comprising a software client or a combined hardware/software client for interfacing with the CS.

Content consumption units may generally relate to devices configured to process file-based and/or (live) streaming content items. Such devices may include a (mobile) content play-out device such as an electronic tablet, a smart-phone, a notebook, a media player, a player for play-out of a recording medium such as a DVD or a Blu-Ray player. In some embodiments, a CCU may be a set-top box or a content recording and storage device configured for processing and temporarily storing content items for future consumption by a further content consumption unit (e.g. a smart-phone or a media player connected to the set-top box or the content recording and storage device).

The content delivery system may comprise a content protection system in order to protect the content items from content or signal theft. The content protection system may comprise a cryptosystem for encrypting and decrypting (the payload of) data units in a content item and a watermarking system for embedding non-perceptible digital information in (the payload of) data units in a content item.

In one embodiment, the content protection system may include a DRM system which may enable a content source, e.g. a content provider, to distribute protected (encrypted) content and service providers (rights issuers) to issue DRM licenses (Rights Objects) for the protected content. When a user wants to access the content, it should acquire a DRM license from the rights issuer. The license contains permissions and keys to “access” the protected content. As the content is cryptographically protected when distributed, the protected content cannot not used without an associated DRM license (rights object) issued for the content processing device.

The cryptosystem may comprise an encryption unit 106 associated with an encryption algorithm, which is configured to encrypt (plaintext) data units into encrypted data units on the basis of at least one encryption key e and a decryption unit 108 associated with an decryption algorithm D, which may be implemented in the CCU 104 and which is configured to decrypt encrypted data units on the basis of a decryption key d. The generation and distribution of encryption and decryption keys e,d may be controlled by a secret key generator KG 110.

In the content delivery system described in this application, encryption and decryption units E,D may be part of a homomorphic cryptosystem exhibiting the property that processing two encrypted data units x₁ and x₂ in accordance with a first algebraic function is equal to processing the two data units x₁ and x₂ in accordance with a second algebraic function in the encrypted domain. In an embodiment, the homomorphic cryptosystem may be an additive homomorphic cryptosystem such that multiplying a first encrypted data unit x₁ encrypted on the basis of a first encryption key e₁ with a second encrypted data unit x₂ encrypted on the basis of a second encryption key e₂ is equal to adding the two data units in the encrypted domain: Eₑ₁(x₁)*Eₑ₂(x₂)=E_{e1,e2}(x₁+x₂)(mod p). In another embodiment, the homomorphic cryptosystem may be a multiplicative homomorphic cryptosystem such that multiplying two encrypted data units x₁ and x₂ is equal to multiplying the two data units in the encrypted domain domain: Eₑ₁(x₁)*Eₑ₂(x₂)=E_{e1,e2}(x₁*x₂)(mod p).

The watermarking scheme according to the present invention may be used with many well-known (conventional) homomorphic cryptosystems. In some embodiments, the first and second encryption key e₁ and e₂ may be identical. In other embodiments, the first and second encryption key may be different. In one embodiment, a symmetric homomorphic cryptosystem such as the one-time pad may be used. In another embodiment, an asymmetric homomorphic cryptosystem may be used, including RSA, El Gamal and Damgard-Jurik cryptosystems. Alternatively, the watermarking scheme may use a special homomorphic cryptosystem such as the split-key cryptosystem. Examples of such cryptosystems will be described hereunder in more detail.

The content source may comprise a content processor 112 CP comprising a processing function, which may be configured to decode and analyze data units of a plaintext content item, e.g. a compressed video file or stream. The processing function may be configured to decode and analyze the payload of data units in the content item (e.g. an encoded and compressed video file or stream) and to identify data units that are suitable for watermarking.

Data units selected by the content processor that are suitable for watermarking may be hereafter referred to as perturbable data units. A perturbable data unit may define a logical data structure, carrying part of the content (payload) in a content file or stream (e.g. (part of) an (encoded) video frame, macro block, video slice or audio frame) that is suitable for insertion of a perturbation signal δᵢ. Perturbation signals may be generated by watermarking system, which is described hereunder in more detail. A perturbation signal may be configured such that when added to the payload of a perturbable data unit—it is not visible or perceptible by an average viewer when rendered. Different perturbation signals δᵢ may be inserted in different perturbable data units. As will be described hereunder in more detail, one or more perturbation signals may be embedded in a content item in the encrypted domain on the basis of simple homomorphic computations, i.e. algebraic functions including: addition, subtraction, multiplication, division, binary operations (e.g. XOR) or a combination thereof. A number of perturbation signals embedded at predetermined positions in a content item may form a watermark. A set of perturbation signals may be referred to as a watermark payload w.

The watermarking system may comprise a watermark generator WG 116 and watermarking embedding unit (WE) 118 (a watermarking embedder) comprising a watermarking embedding function (an embedding function) for embedding a watermark, e.g. non-perceptible (digital) information, in the payload of data units that are delivered to the CCU in encrypted form.

When outsourcing the watermarking process to a content receiving entity, e.g. a CCU or a content distributor such as a CDN, it is important that the watermarking process is executed in a secure way. Hence, in order to force the content receiving entity to watermark a content item that it receives, the content source or—in particular—the content processor in the content source may be configured to add distortion information y to at least part of the content item. In particular, distortion information y, comprising one or more distortion signals yᵢ, may be added to (the payload of) data units of a content item X so that a distorted content item X+y 113 is formed. The distortion signals y, may be configured to distort or inhibit the rendering of the content so that it is no longer suitable for content consumption. The watermark generator 116 is configured to generate a compensating watermark payload 115 on the basis of the distortion information y and, optionally, an transaction identifier 119.

The formation of a distorted content item and the process of watermarking a distorted content item on the basis of the compensating watermark payload are illustrated in FIG. 1B in more detail. The first window 140 of FIG. 1B depicts the process of generating a distorted content item 113 on the basis of distortion information y comprising one or more distortion signals y, 128. A distortion signal may include a randomly generated value or value generated on the basis of a predetermined function. The process may start with the content processor examining data units in a plaintext content item 120 and inserting distortion signals in one or more data units of the plaintext content item so that distorted data units are formed (e.g. data units x₁,x₄,x₅,x₈,x₁₀ in FIG. 1B). One or some of the distorted data units may be perturbable (i.e. suitable for embedding a watermark). Such distorted data unit may be referred to as a distorted perturbable data unit 130 (shaded data units x₁,x₅,x₁₀ in FIG. 1B).

The distorted perturbable data units may form a subset of the total set of distorted data units in the distorted content item. In one embodiment, the distortion signals may be identical. In another embodiment, the one or more distortion signals may differ from each other. During the formation of the distorted content item, the content processor may generate distortion position information identifying the position of each distorted data unit in the distorted content item and identifying the particular distortion signal yᵢ that is added to a distorted data unit at a certain position. The distortion position information may further identify which distorted data units are perturbable.

The second window 142 of FIG. 1B depicts a process of generating a watermarked content item 126 on the basis of a compensating watermark payload and the distorted content item 122. This process may start with a watermarking generator associated with the content source generating a compensating watermark payload w associated with the distorted content item, wherein the compensating watermark payload may comprise one or more compensating watermark signals 124 for compensating the distortion signals in the distorted data units. The watermarking generator may use the distortion position information to identify the position of a distorted (perturable) data unit and to identify the distortion signal yᵢ in the distorted data unit.

A compensating watermark signal may comprise at least a compensating signal −yᵢ such that when the compensating watermark signal is combined with the distorted (perturbable) data in the encrypted domain, the distortion signal y is compensated. A compensating watermark signal for a distorted perturable data unit may comprise a watermark signal δᵢ in addition to the compensating signal −y₁. When such compensating watermark signal δᵢ−yᵢ is combined with a distorted perturbable data unit, the distortion signal yᵢ in the data unit is compensated and a watermark signal is embedded into the data unit thus forming a perturbed data unit xᵢ+δᵢ, i.e. a data unit comprising a watermark signal.

Hence, the compensating watermark payload may be used for both compensating the distortion signals and for embedding watermark signals into the content item. Combining the compensating watermark payload with the distorted content item may result in a watermarked content item 126 comprising data units with a watermark signal (a perturbed data unit 136) and zero distortion signals. The watermark may be formed by a particular combination of watermark signals δᵢ that are combined with the distorted perturbable data units, wherein during the rendering process the watermarking signals δᵢ will not be perceptible for the user.

During the generation of the compensating watermark payload for a distorted content item, watermarking position information may be generated by the watermarking generator. The watermarking position information may identify the compensating watermark signals in the compensating watermark payload and may link each of the compensating watermark signals with a position of a distorted (and optionally perturbable) data unit in the distorted content item. The watermarking position information may be used by the watermark embedder in order to identify encrypted distorted (and optionally perturbable) data units in an encrypted distorted content item and to correctly combine these encrypted distorted (and optionally perturbable) data units with encrypted compensating watermark signals in the compensating watermark payload. The watermarking position information may be determined in the plain domain. A homomorphic encryption algorithm typically encrypts the data units of a distorted content item in blocks (e.g. 1024 or 2048 bits or in case of the one-time pad even larger) resulting in encrypted block of the same size or in some cases (like Pallier) twice the size of the plaintext block. Hence, encrypting a distorted data unit, e.g. a 6-bits DTC coefficient, in a plaintext block results in an encrypted distorted data unit in a cipertext block. When encrypting the compensating watermark signal for the encrypted distorted data unit in the cipertext block, an encrypted compensating watermark signal (block) will be generated which is of the same size of the ciphertext block comprising the distorted data units so that the encrypted data can be easily combined using a homomorphic computation.

Hence, from the above it follows, that distorted data units in the distorted content item “force” a content receiving entity to combine the compensating watermark payload with the distorted content item on the basis of the watermarking position information. If the distorted content item is not combined with the compensating watermark payload, the rendering of the content item will be distorted or even inhibited. In embodiments of the invention the distortion signal is both added to perturbable and non perturbable data units. The associated compensating watermark signal compensates for the added distortions in a manner that only the perturbable data-units remain perturbed (because of the added watermark). Adding a distortion signal to both perturbable data units and non-perturbable data units provides the advantage of hiding the distorted perturbable data units that are determined for watermarking between a large number of distorted data units, even when only few positions in the content item are determined as perturbable. Since the watermarking itself takes place in the encrypted domain, secure watermarking is achieved by adding the compensating watermark signals to only a number of selected data units, without the watermarking entity knowing where the watermark is embedded in the content item.

The process of combining the watermark payload 124 with the distorted content item 122 into a watermarked content item 126 as depicted in the window 142 of FIG. 1B is performed in the encrypted domain using properties of the homomorphic cryptosystem.

Hence, as schematically depicted in FIG. 1A, the distorted content item, or at least the part in the distorted content item, comprising the distorted data units, may be encrypted by the encryption unit 106 on the basis of a homomorphic encryption algorithm E and an encryption key e₁ into an encrypted distorted content item Eₑ₁(X+y) 124. Similarly, the compensating watermark payload w-y may be encrypted on the basis of the homomorphic encryption algorithm E and an encryption key e₂ in order to form an encrypted compensating watermark payload Eₑ₂(w-y) 122. Thereafter, the encrypted distorted content item Eₑ₁(X+y) and the encrypted compensating watermark payload Eₑ₂(w-y) may be sent to a watermark embedder 118 in the content receiving device 104. The watermark embedder may further receive the watermarking position information 114 from the content source so that the watermarking embedder is able to identify distorted data units in the encrypted distorted content item and find for each distorted data unit an associated compensating watermark signal in the encrypted compensating watermark payload.

The watermark embedder may then combine an encrypted distorted (perturbable) data unit with its associated encrypted compensating watermark signal in the encrypted domain using an homomorphic computation, e.g. an additive homomorphic computation. This way an encrypted watermarked content item E_{e1,e2}(X+W) 126 may be formed.

For example, when using an additive homomorphic split-key cryptosystem, multiplying an encrypted distorted data unit Eₑ(xᵢ+yᵢ) with an associated encrypted compensating signal Eₑ(δᵢ−yᵢ) may result in an encrypted perturbed data unit Eₑ(xᵢ+δᵢ), i.e. Eₑ(xᵢ+yᵢ)*Eₑ(δᵢ−yᵢ)=Eₑ(xᵢ+δᵢ). A similar result may be achieved using a multiplicative homomorphic split-key cryptosystem. In that case, multiplication of encrypted distorted data unit Eₑ(xᵢ*yᵢ) with an associated encrypted compensating signal Eₑ(δᵢ/yᵢ) may result in an encrypted perturbed data unit Eₑ(xᵢ*δᵢ).

In general, an encrypted distorted data unit Eₑ(x+y) may be transformed into an encrypted perturbed data unit Eₑ(x+δ) wherein the “+” symbol denotes any suitable operation for changing one or more bits in the (payload of the) perturbable data unit. In case the distorted content item is formed by addition of a perturbation to (part of) the payload of data unit, the compensating watermark may be embedded using a subtraction of a perturbation from (part of) the payload of that (perturbed) data unit, so that when the encrypted compensating watermark is embedded into the encrypted distorted data unit, the distortion signal is removed (compensated). Numerous ways for forming distorted content items and associated compensating perturbations are possible using the above scheme, e.g. addition, subtraction, multiplication, division, binary operations (e.g. XOR) or combinations thereof.

In an embodiment, the compensating watermarking payload 115 may be generated in reaction to a user requesting the delivery of a content item. In response to the user request, the content source may generate a transaction identifier ID 119 on the basis of a user identity, a client identity, a CCU identity, a content source identity, a transaction identifier, a transaction timestamp, etc. and/or combinations thereof. The watermark generator 116 may then generate a watermark payload w comprising a predetermined number of perturbation signals δ on the basis of the transaction identifier ID. This way a watermark in a content item may be linked to a particular transaction, client and/or content source.

In an embodiment, a perturbation signal δᵢ may be a digital signal that may change one or more bits in the payload of a data unit from “0” to “1” or vice-versa. For example, an encrypted distorted content item Eₑ₁(X+y) may comprise encrypted distorted data units Eₑ₁(xᵢ+yᵢ) at positions j=1001, 2004, 2248, 8888 and 9233. When the content item is requested, a transaction identifier in the form of a sequence of bits “10001” may be generated. On the basis of this identifier, the distortion signal is generated. Further an encryption key e₂ may be generated in order to determine a set of five encrypted compensating signals Eₑ₂(δᵢ−yᵢ), i=1, . . . , 5, wherein 6, is “1” for i=1,5 and “0” for i=2, . . . , 4. Subsequent embedding of these compensating signals into the distorted data units on the basis of a homomorphic algebraic operation results in an encrypted watermarked content item E_{e1,e2}(X+w). Many variations of embedding watermark signals in a distorted content item are possible. For example in another embodiment a plurality of bits may be embedded in a distorted data unit.

The encrypted watermarked content item may be subsequently decrypted into a clear text watermarked content item X+w by the encryption unit in the CCU on the basis of a decryption key d, which is sent by the key generator 110 to the decryption unit 108 in the CCU. After the embedding process, the encrypted watermarked content item may decrypted on the basis of an encryption algorithm and a suitable decryption key d, which is provided by the key generator 110 to the decryption unit 108 in the CCU.

Hence, from FIG. 1A and 1B it follows that combining compensating signals with the payload of distorted data units in the encrypted domain allows the distorted data units (producing a distorted video signal when rendered) to be transformed in perturbed data units wherein the perturbation signals in the payload of these data units form a watermark that may be detectable using forensic techniques. The watermarking technique is secure as the whole process is performed in the encrypted domain and forces a content receiving entity such as the CCU to combine the compensating signals with the distorted data units so that manipulation of the watermarking process may be substantially reduced. As only a limited number of data units are distorted, the size of the encrypted compensating signals that need to be sent to the CCU will be small thereby making the technique suitable for (HD) video streaming techniques to a large number of CCUs. Moreover, the small size of the encrypted compensating signals further enables different watermarking of a content item for different clients.

The watermarking process as described with reference to FIG. 1A and 1B may be used in streaming applications. An embodiment of such streaming application is depicted in FIG. 1C. In this particular embodiment, the content processer 112 in the content source 102 may generate a distorted content stream 113, e.g. a MPEG-encoded distorted (live) content stream, on the basis of distortion information and distortion position information as described with reference to FIG. 1A en 1B. When a content receiving entity, e.g. a streaming client 104, requests the content source to join a live streaming event, it may send a request to the content source for joining the streaming event. Further, a watermarking generator 116 may generate a compensating watermarking payload w-y 115 and watermarking positioning information 114. The compensating watermarking payload may be generated on the basis of a transaction identifier 119 so that the watermark that is going to be embedded in the stream can be linked to a particular client and/or content source.

An encryption unit 106 in the content source may start encrypting the distorted content stream and the encrypted distorted data 124 may be streamed to the requesting client. Further, the encryption unit may start encrypting the compensating watermark payload and send the encrypted compensating watermark signals 122 to the client. For streaming applications—like live content streaming—a fast and efficient additive cryptosystem may be used.

In one embodiment, a symmetric additive homomorphic cryptosystem known as the “one-time pad” may be used. The one-time pad cryptosystem may be used as a stream cipher or a block cipher. In case of a block cipher with block size N is used, the distorted stream 113 may be divided in data blocks 111 of size N wherein each data block (block) B is encrypted on the basis of a secret key, i.e. a random number e between 0 and N. Encryption may be achieved by adding the secret key e to the block B: Eₑ(B)=(B+e) mod N. Decryption may be achieved by the opposite operation: D(C)=(C-e) mod N wherein C is the decrypted block B. Secret keys may be generated on the basis of a secret pseudo-random generator RAN 150 and a secret key generating function F 152. The pseudo-random generator may generate seeds, i.e. random values Sᵢ 154, wherein the different random values may be used by the secret key generating function F to generate different secret keys eᵢ, which are forwarded to the encryption unit.

Hence, the data units in the distorted stream are encrypted in blocks B, 154 by the encryption unit E, which may receive for each block B, a different key e, from the secret key generating function F. The key generator may generate the keys e, on the basis of different seeds Sᵢ that are generated by a secret pseudo-random generator RAN. Some of the encrypted blocks that are streamed to the client may comprise a number of data units, wherein some of these data units may be (perturbable) distorted data units and wherein the positions of these (perturbable) distorted data units are identified by the distortion position information (as described in detail with reference to FIG. 1A and 1B).

In an embodiment, each time the encryption unit receives a block comprising one or more distorted signals (which may be referred to as a distorted block), the encryption unit may use the same secret key for encrypting both the distorted block and the compensating watermark signal 115, wherein the compensating watermark signal has the same block size as the (distorted) blocks in the distorted stream. This way, encrypted distorted blocks 124 and associated encrypted compensating watermark signals (blocks) 122 are sent to the streaming client.

The watermark embedder 118 may receive the encrypted blocks and the encrypted compensating watermark signals. The watermark embedder may use watermarking position information 114 (as described in detail with reference to FIG. 1A and 1B) to combine encrypted distorted blocks with encrypted compensating watermark signal in the encrypted domain using a homomorphic computation, e.g. a simple homomorphic addition: E(xᵢ+yᵢ)E(δ₁−yᵢ)=E(xᵢ+δᵢ).

This way, an encrypted watermarked stream 126 is formed comprising a sequence of encrypted blocks wherein certain encrypted blocks may comprise data units comprising a watermark signal. The client may comprise a decryption unit 108 for decrypting the encrypted blocks on the basis of secret keys e, that were also used for encrypting the blocks. To that end, the pseudo-random generator may send the seeds Sᵢ 154 to a secret key generating function F 152 in the client that uses the seeds to generate the secret keys e, for decrypting the blocks into a plaintext watermarked content stream. The client may further comprise a media engine for decoding the encoded data units into e.g. a sequence of frames 156 that are processed by a media engine for play-out wherein some of the frames may comprise a watermark signal.

The streaming process depicted in FIG. 1C may be used using a conventional broadcasting (e.g. DVB) of multicasting technique. In another embodiment, the streaming process depicted in FIG. 1C may be based on an adaptive streaming protocol such as HTTP adaptive streaming (HAS) protocol may be used. Examples of adaptive streaming protocols include: Apple HTTP Live Streaming [http://tools.ietf.org/html/draft-pantos-http-live-streaming-07], Microsoft Smooth Streaming [http://www.iis.net/download/SmoothStreaming], Adobe HTTP Dynamic Streaming [http://www.adobe.com/products/httpdynamicstreaming], 3GPP-DASH [TS 26.247 Transparent end-to-end Packet-switched Streaming Service (PSS); Progressive Download and Dynamic Adaptive Streaming over HTTP] and MPEG Dynamic Adaptive Streaming over HTTP [MPEG DASH ISO/IEC 23001-6]. HTTP allows an efficient, firewall-friendly and scalable scheme for delivering segments to clients.

In HAS solutions a content stream is usually partitioned into segments (also referred to as “chunks”) wherein each of these segments may be encoded in different quality levels (representations). The segments and their different representations are described in a so-called manifest file (also known as a Media Presentation Description or MPD for MPEG-DASH or M3U8 playlist for Apple HTTP Live Streaming), which may comprise information about the segments in the stream (segment identifiers), location information e.g. one or more URLs associated with HTTP servers that are configured to stream segments to a client and the temporal relation between different segments in the stream. A HAS streaming client in a content processing device may use a manifest file to request segments from the network and process the segments for play-out. The HAS streaming client may be configured to switch between different representations depending on network conditions.

A watermarking process as depicted in FIG. 1C may be implemented in a HAS streaming system, wherein streaming is achieved by sending segments identified in a manifest file to the HAS streaming client. In that case, the content source may add distortion information the segments and a watermark generator may generate compensating watermark payload in a similar ways as described with reference to FIG. 1C. Hence, in case a HAS client would like to join a predetermined steaming event, it will receive a manifest file identifying the segments and location information for requesting the segments from one or more HTTP servers. When streaming the segments to the HAS client, at least part of the segments may be encrypted using a homomorphic cryptosystem, e.g. a block cipher on the basis of the one-time pad algorithm. In that case, segments may comprise one or more encrypted blocks wherein some segments may comprise one or more encrypted distorted blocks, i.e. encrypted blocks comprising one or more distortion signals.

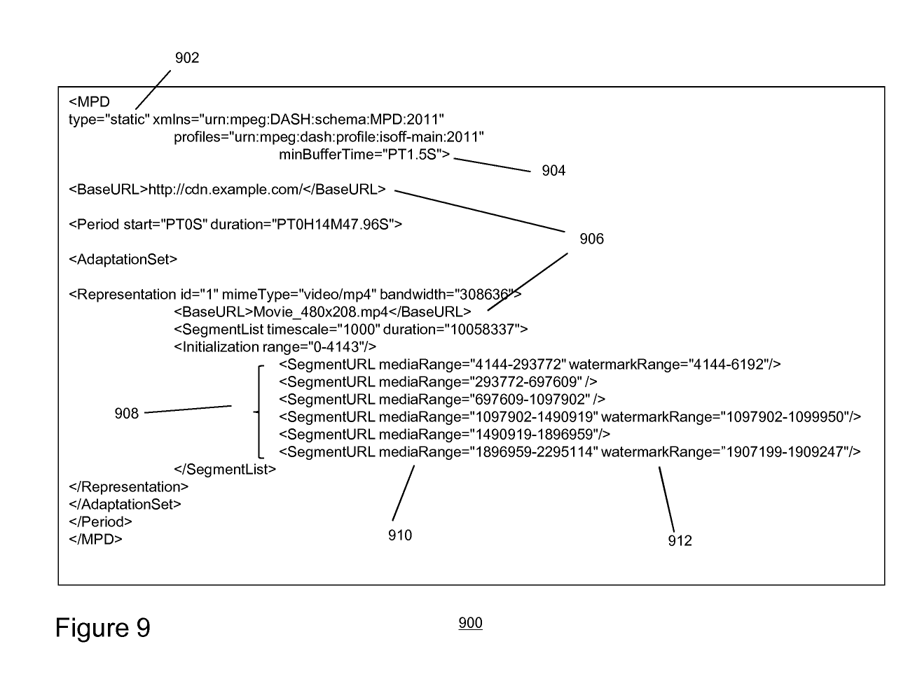

A watermark embedder in the HAS client may combine an encrypted distorted block with an encrypted compensating watermark signal using one or more homomorphic computations. The watermark embedded may use watermarking position information to localize the distorted data units in a segment. At least part of the watermarking position information may be inserted in the manifest file that is sent to the HAS client, when it requests to join a streaming event. This way, a HAS client may use the manifest file to identify (encrypted) segments and to localize distorted data units therein. An example of at least part of such manifest file is described in more detail with reference to FIG. 9.

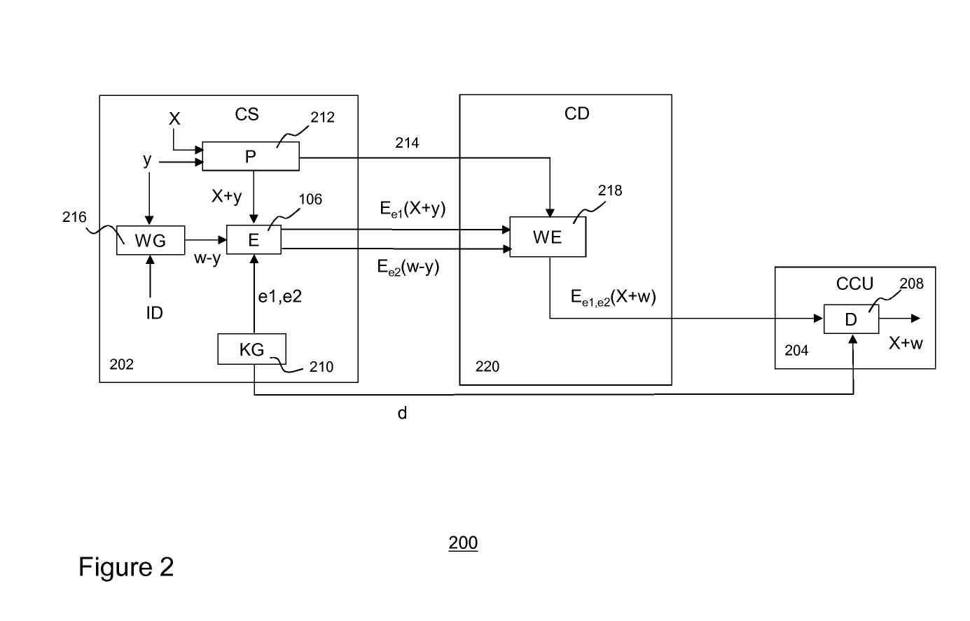

FIG. 2 depicts a schematic of content delivery system according to another embodiment of the invention. In particular, FIG. 2 depicts a content delivery system 200 comprising a content source 202, (CS), and a content distributor 220 configured for delivering content items to at least one content consumption unit (CCU) 204.

The content source may comprise a content processor 212 comprising a processing function that may be configured to decode and analyze the payload of data units in the content item; to select data units that are suitable for watermarking; to determine watermarking position information regarding the position of data units in the encrypted content item that are selected by the content processor for watermarking; and, to send the watermarking position information 214 to the content distributor. Further, the content processor may be configured to add one or more distortion signals y to (the payload of) data units of a content item X so that a distorted content item X+y is formed.

The content source may further comprise a watermark generator 216 for generating a compensating payload w-y (comprising one or more compensating signals δ−y) on the basis of a transaction identifier and one or more distortion signals y; a key generator to generate encryption keys, e.g. first and second encryption key e1 ,e2, and a decryption key d and to send these keys to the encryption unit in the content source and the decryption unit in the CCU respectively. The encryption keys may be used by the encryption unit to generate an encrypted distorted content item Eₑ₁(X+y) on the basis of the first encryption key e1 and an encrypted compensating payload Eₑ₂(w-y) on the basis of a second encryption key e2, wherein the encrypted compensating payload may comprise one or more encrypted compensating signals Eₑ₂(δ₁−y₁), Eₑ₂(δ₂−y₂), etc. The encrypted compensating payload and the encrypted distorted content item may be sent (together with the watermarking position information) to the watermark embedder in the content distributor.

In this particular embodiment, the watermarking process is outsourced to the content distributor. To that end, the content distributor comprises a watermarking embedder 218, which receives the watermarking position information and the encrypted distorted content item and compensation payload. The content distributor may generally relate to a content distribution platform or a chain of different content distribution platforms configured to distribute content from the content source to the content consumption units. A content distributor may use electronic means for delivering content e.g. one or more content delivery networks (CDNs). Alternatively or in addition, a content distributor may use physical means for delivering content, e.g. a recording-medium such as a magnetic recording medium, an optical recording medium using e.g. DVD and Blu-Ray technology or an opto-magnetic recording medium.

A CDN may comprise a number of delivery nodes for storing and delivering (part of) a content item to a CCU and a central CDN node for controlling ingestion of content items into the CDN from an external source and for managing the distribution of copies of a content item over one or more delivery nodes in the CDN. CDNs are especially suited for delivery of so-called segmented or tiled content. For example, HTTP adaptive streaming (HAS), Scalable Video Coding (SVC) and spatially segmented video (e.g. tiled video) use segmentation on the basis of time, quality and space respectively. A so-called manifest file (also known as a Media Presentation Description or MPD for MPEG-DASH or M3U8 playlist for Apple HTTP Live Streaming) describes the relation between the different segment files and/or streams and the location where the segments may be retrieved.

In order to enable a client in a CCU to access stored content in a CDN, the client may be provided with the manifest file so that it is able to retrieve the segments. Segment file or segment stream (in a short a segment) identified in the manifest file may be retrieved by a file retrieval protocol, e.g. HTTP or FTP, or a streaming protocol, e.g. RTSP/RTP or HAS. Further, a video title, or more in general, a content item rendered by a segmentation scheme may be referred to as a segmented content.

From the embodiment of FIG. 2 it follows that all data, which are sent to the content distributor, are encrypted, copies distributed within the content distributor are encrypted and during the watermarking a content item stays encrypted. Hence, the whole process of distribution and watermarking is performed in the encrypted domain. Moreover, the watermarking scheme “forces” the content distributor to combine the compensating signals with the distorted data units so that manipulation of the watermarking process may be substantially reduced.

In an embodiment, the first and second encryption key may be identical. In that case, the encryption and decryption algorithms and the cipher algorithm may be part of a conventional homomorphic cryptosystem such as RSA, El Gamal or Damgard-Jurik. In another embodiment, the encryption and decryption algorithms and the cipher algorithm may be part of an additive homomorphic cryptosystem known as the Pallier cryptosystem. In that case the first and second encryption keys e₁,e₂ are different. The encryption keys e₁ and e₂ for the Pallier cryptosystem may be generated using a cipher algorithm for executing the following steps:
Determine n=p*q to the modulus of the Pallier cryptosystem wherein p and q are two large prime numbers;
Arbitrarily split n into n1 and n2 such that n=n1+n2;
Select an arbitrarily positive integer r<n;
Determine first encryption key e₁=(n,n1,r);
Determine second encryption key e₂=(n,n2,r);

On the basis of the above-mentioned encryption keys, one or more data units in a content item and one or more perturbation signals δ may be partially encrypted in accordance with the following encryption algorithm E:

Eₑ₁(x)=(n+1)^{x}* rⁿ¹ mod n²;

Eₑ₂(δ)=(n+1)⁶* rⁿ² mod n²;

Multiplying both encrypted parts results in Eₑ₁(x)*Eₑ₂(δ)=(n+1)^{x+δ}*rⁿ mod n²=Eₑ₁₊ₑ₂(x+δ) and shows the additively homomorphic property of the Pallier cryptosystem. The same calculation may be performed for a perturbation signal δ in combination with distortion signal by replacing x with x+y and 6 with δ−y. This process may be executed by the watermark embedding unit of the content distributor before it is sent to the content consumption unit.

It is submitted that the term “partial encryption” in the context of a Pallier cryptosystem refers to an encryption operation E on at least part of a content item X using Pallier encryption key e₁. The content item is partially encrypted because it cannot be decrypted on the basis of the Pallier decryption key d. In a Pallier cryptosystem the first partially encrypted content item needs to be multiplied with the second partially encrypted content item before it can be decrypted using the Pallier decryption key d. A partially encrypted content item does not refer to a situation wherein only a part of the content item is encrypted. In this application, the term encryption may be interpreted as “partial encryption” if this term is used in the context of a Pallier cryptosystem.

The encrypted watermarked content may be decrypted by the CCU on the basis of a decryption key d=LCM(p-1,q-1) which is sent by the key generator 316 to the CCU. In this expression, LCM indicates the Least Common Multiple, and the decryption algorithm D may be defined as:

D_{d}(Eₑ₁₊ₑ₂(x+δ))=D_{d}(c)=((c^{d}−1)mod n²/(d*n)mod n²) mod n=(x+δ) mod n, where c=Eₑ₁₊ₑ₂(x+δ)=(n+1)^{x+δ}*rⁿ mod n²

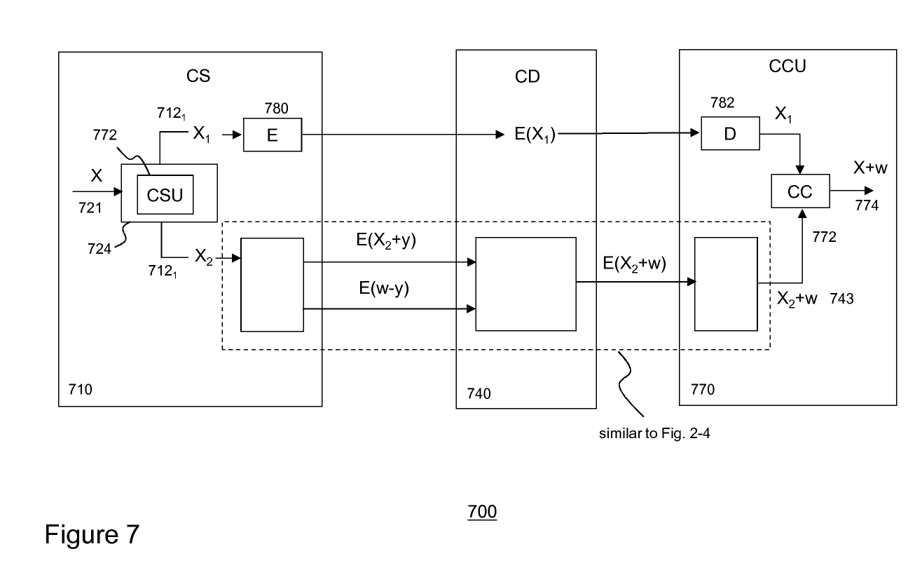

When using the Pallier cryptosystem, only a part of a content item comprising the distorted data units is encrypted. This way, the size of the encrypted compensation payload can be kept sufficiently small. The other parts that do not comprise the distorted data units may be encrypted using a more efficient (symmetrical) cryptosystem (e.g. AES). This process in described hereafter in more detail with reference to FIG. 7.

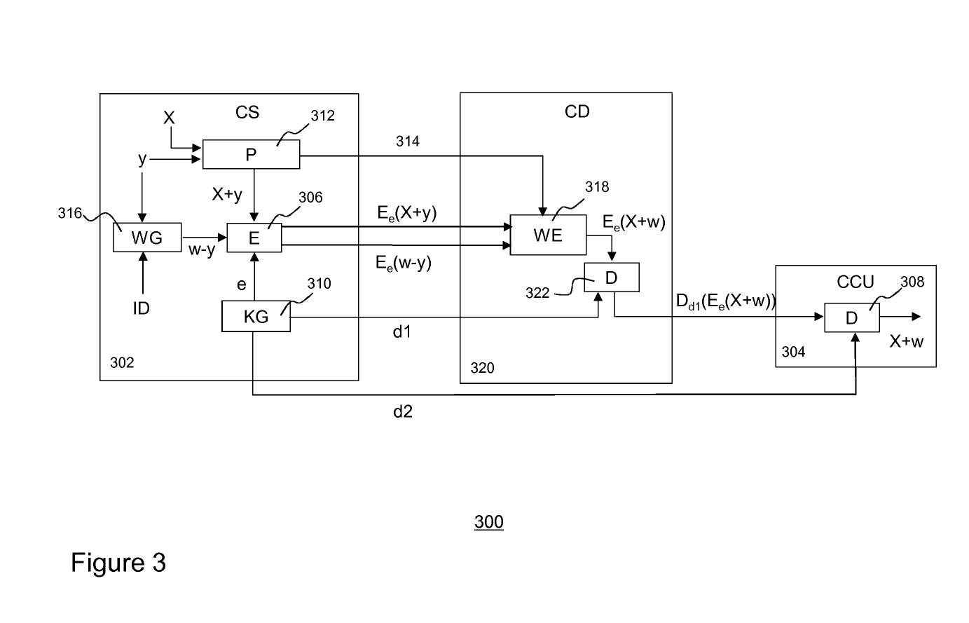

FIG. 3 depicts a schematic of a content delivery system according to an embodiment of the invention. In particular, FIG. 3 depicts a schematic of a content delivery system configured for securely watermarking and delivering a content item to a content consumption unit using a so-called homomorphic split-key cryptosystem.

The homomorphic split-key cryptosystem may comprise at least one encryption unit 306 associated with the content source 302 comprising a homomorphic encryption algorithm E and one or more decryption units 308,322, in the content distributor 320 and the CCU 304 respectively, wherein a decryption unit may comprise a homomorphic decryption algorithm D. The split-key cryptosystem may further comprise a secret key generator 310 associated with the content source, wherein the secret key generator comprises a cipher algorithm for generating encryption and decryption keys e,d and a split-key algorithm for splitting encryption key e into i different split-encryption keys e₁,e₂, . . . , eᵢ and/or for splitting decryption key d into k different split-decryption keys d₁,d₂, . . . , dₖ respectively (i,k≧1 and i+k>2); wherein executing i consecutive (split-key) encryption operations and k consecutive (split-key) decryption operations on a content item X using said split-encryption and split-decryption keys respectively, generates a fully decrypted content item X, i.e.: D_{dk}(D_{dk-1}( . . . (D_{d2}(D_{d1}(Eₑᵢ(Eₑᵢ₋₁( . . . (Eₑ₂(Eₑ₁(X)) . . . ))=X.

Here the term “fully decrypted” may refer to the result of the execution of i consecutive encryption operations and k consecutive decryption operations on content item X (as input) on the basis of i split-encryption keys and k split-decryption keys respectively, so that a fully decrypted content item D_{dk}(D_{dk-1}( . . . (D_{d2}(D_{d1} (Eₑᵢ(Eₑᵢ₋₁( . . . (Eₑ₂(Eₑ₁(X)) . . . )=X is generated. A fully encrypted content item is identical to the content item which is used as input. Hence, a fully decrypted content item may be in clear if a clear text content item X is used as input to the encryption and decryption operations; or it may be an encrypted content item if an encrypted content item X is used as input to the encryption and decryption operations.

It is submitted that the term “partial encryption” or “partial decryption” in the context of a split-key cryptosystem refers to an encryption operation E or decryption operation D on at least part of a content item using a spit-encryption key or split-decryption key respectively. A partially decrypted content item does not refer to a situation wherein only a part of the content item is decrypted into plain text on the basis of a decryption algorithm of conventional cryptosystem (other than a split-key cryptosystem). A partially decrypted or encrypted content item is cipher text and as such as secure to unauthorized access as fully encrypted content. In this application, the terms decryption and encryption may be interpreted as “partial decryption” and “partial encryption” if these terms are used in the context of a split-key cryptosystem.

Examples of various homomorphic split-key cryptosystems will be explained hereunder in greater detail.

The content source 302 may further comprise similar functional elements as described with reference to FIG. 2. The content source may comprise a content processor 312 comprising a processing function for determining watermarking position information regarding the position of data units in the encrypted content item that are selected by the content process for watermarking and to generate a distorted content item X+y on the basis of one or more distortion signals y.

The content source may comprise: a watermark generator 316 for generating a compensating payload w-y (comprising one or more compensating signals δ−y) on the basis of a transaction identifier and the one or more distortion signals y; a key generator 310 configured to generate at least one encryption key e and at least first and second split-decryption keys d₁,d₂; an encryption unit 306 for encrypting compensating payloads originating from the watermark generator and distorted content items originating from the content processor on the basis of at least one encryption key from the key generator.

The content distributor may comprise a watermark embedder 318 for combining a compensating payload with a distorted content item in the encrypted domain in order to watermark the content item and at least one decryption unit 322 for partially decrypting an encrypted watermarked content item before it is sent to the CCU for further decryption.

The encryption key e may be used by the encryption unit to generate an encrypted distorted content item Eₑ(X+y) which may be sent (together with the watermarking position information) to the content distributor 320. The content distributor, e.g. an CDN, may store (multiple copies of) the encrypted distorted content item on one or more delivery nodes of the CDN for future use.

When a CCU requests a content item from the content source, e.g. a service provider, the watermark generator may generate an identifier for identifying the transaction with the first consumer (a transaction ID). Further, on the basis of the identifier and the distortion signal y, the watermark generator may generate a compensating payload w-y, which is subsequently encrypted by the encryption unit into an encrypted compensating payload Eₑ(w-y), wherein the encrypted compensating payload may comprise one or more encrypted compensating signals Eₑ(δ₁−y₁), Eₑ(δ₂−y₂), etc.

The encrypted compensating payload Eₑ(w-y) is sent to the watermark embedder in the content distributor, which combines the compensating payload with the encrypted distorted content item using the watermarking position information in the encrypted domain using an homomorphic algebraic operation. The thus generated encrypted watermarked content item Eₑ(X+w) is fed into a decryption unit where it is subjected to a (split-key) decryption operation on the basis of decryption algorithm D and a first split key dl originating from the key generator. This way a partially decrypted watermarked content item D_{d1}(Eₑ(X+w)). The partially encrypted watermarked content item is subsequently sent to the decryption unit 308 of the CCU, which fully decrypts partially encrypted watermarked content item into a watermarked content item X+w using a second split-decryption key d₂.

Hence, an encrypted distorted content item may be processed and stored at the content distributor. Thereafter, multiple CCUs may request the content item, wherein on the basis of the above-described process the content provider is “forced” to watermark the content before it is sent to the CCU, wherein each CCU may receive a differently watermarked and differently encrypted (partially decrypted) content item.

The use of other watermark payload than the (encrypted) compensating payload will render the content item not suitable for display. It thus forces a content distributor to watermark the content in accordance with the specifications as provided with the content source (content provider). This way, it is not possible or at least very difficult for a rogue employee of a content distributor to manipulate the watermarks.

Furthermore, in contrast with the known methods for delivering encrypted and watermarked content items to a large number of consumers, some embodiments according to the disclosure allow watermarking and encryption of a content item, such that every content item delivered to a consumer is differently encrypted and watermarked. Each consumer will receive a differently watermarked and encrypted (partially decrypted) version of a content item so the method is safe against signal theft by a rogue consumer.

Hence, from the above it follows that the non-watermarked encrypted distorted content Eₑ₁(X+y) stored with the content distributor for further use, cannot be decrypted into clear text that is suitable for content consumption, neither by the content distributor, nor by a consumer having a decryption key, nor by their collusion. Moreover, the properties of the homomorphic split-key cryptosystem allow outsourcing of the generation of encrypted compensating watermarks Eₑ₂(w-y) to a third party, e.g. the CCU or the content distributor. Such implementation reduces processing time at the side of the content source and the traffic between the content source and the content distributor as encrypted compensating perturbations Eₑ₂(w-y) typically comprise more bits than the compensating perturbations.

Further, as the watermark is only added upon a consumer transaction, multiple CDNs could get the same encrypted version. This may save processing efforts in CDN interconnect scenarios in which a content source uses multiple content distributors (in parallel or cascade) to deliver the content to consumers, as the processing needs to be performed only once per content item instead of once per content item/content distributor combination.

Hereunder several homomorphic split-key cryptosystems are described in more detail. In an embodiment, the split-key cryptosystem may be based on an additive homomorphic cryptosystem known as a Damgard-Jurik (DJ) cryptosystem. The encryption- and decryption keys e,d for the DJ cryptosystem may be generated using the following cipher algorithms:

Select two large prime numbers p′ and q′ such that p=2p′+1 and q=2q′+1 are prime too and wherein n=p*q is defined as the modulus of the DJ system;
Select a generator g that generates all squares of the multiplicative group {1, . . . , n−1} mod n. The group of all squares will have size T=p′*q′;
Select d as a random value d ∈ {1, T-1} and compute h=g^{d} mod n;
Determine the (public) encryption key e=(n,g,h).

Note that the encryption key e is called “public” because it may be published without leaking secret information. In one embodiment, encryption key e may be published to enable third parties (e.g. users that generate and upload user-generated content) to encrypt content for the system, while the content source remains in full control over the (partial) decryption steps. In another embodiment, when there is no need to publish the encryption key e, it may be kept private.

The values p, q and d may be stored as secret information S together with public key e=(n,g,h). The value of n needs to be shared with the content distributor and the CCU, as these entities require n to perform their encryption and decryption operations. The value of n may be included in protocol messages exchanged during a content transaction between a content source and a CCU. In one embodiment, multiple transactions may use the same secret information. In that case n would need to be communicated to the content distributor and the CCU only once.

A content item X may be processed on the basis of an agreed-upon reversible protocol known as a padding scheme, which turns X into an integer x wherein 0<x<n. If the process determines that X is too long, it may divide X in blocks that each satisfies the length requirement. Each block is thereafter separately processed in accordance with the padding scheme. An encryption algorithm Eₑ(X) for encrypting content X into Xₑ may comprise the steps of:
selecting a random number r ∈ {0, . . . , n−1};
computing g′=g^{r} mod n and h′=h^{r} mod n such that Xₑ=Eₑ(X, r)=(Y₁,Y₂)=(g′, h′ⁿ*(n+1)^{x} mod n²).

The decryption algorithm D_{d}(Y₁,Y₂) for decrypting an encrypted content item Xₑ may comprise the steps of:
calculate H′=(Y₂*g′^{(-d′n)})(mod n²)
determine x=X_{e,d}=(H′−1)*n⁻¹ mod n²

This indeed gives the desired result X_{e,d}=D_{d}(Y₁,Y₂)=X because H′=((n+1)^{x})(mod n²)=(n*X+1)(mod n²).

A split-key algorithm for determining a pair of split-decryption keys d₁ and d₂ may comprise the steps of:
determine d₂ to be a random number d₂ ∈ E {0, . . . , n−1};
compute d₁=(d−d₂) mod n.

A first decryption operation on the basis of decryption algorithm D and d₁ may be used to “partially” decrypt” encrypted content Eₑ(X) into E_{e,d1}(X) by calculating D_{d1}(Eₑ(X))=D_{d1}(Y₁,Y₂)=(Y₁, Y′₂)=(Y₁,(Y₁^{(-d}₁^{*n)}*Y₂)(mod n²)). Hence, “partially” decrypted content E_{e,d1}(X)=X_{e,d1} is represented by the pair (Y₁,Y′₂).

In one embodiment, if multiple transactions are based on the same secret information and the same random number r, then Y₁ does not change and may need to be communicated to the content distributor and the CCU only once.

A second decryption operation on the basis of algorithm D and d₂ may be used to determine the fully decrypted content by calculating H′=(Y₁^{(-d2*n)}*Y′₂)(mod n²) and x=((H′−1)*n⁻¹) mod n². Indeed, H′=(Y₁^{-(d2+d1)n}*Y₂) mod n²=(Y₂*g′^{(-d*n)})(mod n²) thus showing the correctness of the split-key cipher.

The above split-key DJ cryptosystem may be easily generalized to a multiple split-key cryptosystem with k split-decryption keys. To that end, instead of choosing d₁ and d₂ such that d₁+d₂=d mod n, k−1 random integers d₁ . . . dₖ₋₁ smaller than n may be selected and the final integer may be computed as dₖ=d−(d₁+ . . . +dₖ₋₁) (mod n).

The DJ decryption algorithm D is commutative, so the decryption keys may be generated in any desired order and the decryption operations may be performed in any desired order.

The same holds for the encryption algorithm. Moreover, the DJ cryptosystem is a probabilistic encryption scheme, which prevents eavesdroppers from recognizing the content.

In one embodiment, a split-key cryptosystem may be based on a multiplicative homomorphic RSA cryptosystem. In that case, an encryption/decryption key pair e,d using the following cipher algorithms:
Randomly select two distinct prime numbers p and q of similar bit-length;
Compute n=p*q;
Compute φ(n)=(p−1)*(q−1) wherein φ is Euler's so-called totient function;
Randomly select an integer e such that 1<e<φ(n) and gcd(e,φ(n))=1 (i.e., e and φ(n) are coprime);
Determine d by calculating the multiplicative inverse of e (mod φ(n)), i.e.: d=e⁻¹(mod φ(n)).

The parameters p, q, φ(n), e, d and n may be stored as secret information for further use if necessary. In particular, the value n needs to be shared with the content distributor and the CCU, as these entities require n to perform their encryption and decryption operations. The value n may be transferred to the content distributor and the CCU in protocol messages associated with a content transaction. In one embodiment, when multiple transactions use the same secret information, n needs to be communicated only once.

A content item X may be processed on the basis of an agreed-upon reversible protocol known as a padding scheme, which turns X into an integer x wherein 0<x<n. If the process determines that X is too long, it may divide X in blocks that each satisfies the length requirement. Each block is thereafter separately processed in accordance with the padding scheme.

The RSA encryption algorithm E for encrypting X into Xₑ may be calculated as follows:

Xₑ=Eₑ(X)=x^{e}(mod n).

A split-key algorithm for determining a pair of split-decryption keys d₁,d₂ may comprise the steps of:

selecting an integer d₂ randomly such that 1<d₁<φ(n) and wherein d₁ and φ(n) are coprime; determining d₂=d₁⁻¹*d (mod φ(n)).

A first decryption operation based on decryption algorithm D and split-encryption key d₁ may generate a “partially” decrypted content item by calculating X_{e,d1}=D_{d1}(Xₑ)=(Xₑ^{d1})(mod n) (Read: Xₑ to the power d₁ followed by a modulo n operation). A second decryption operation based on decryption algorithm D and split-encryption key d₂ may generate X_{e,d1,d2}=D_{d2}(X_{e,d1})=(X_{e,d1}^{d2})(mod n). The original plaintext content item X may be derived from X_{e,d1,d2} by applying the padding scheme in reverse.

Since the RSA encryption and decryption algorithms E and D are identical, the split-key algorithm for determining a pair of split-encryption keys e₁,e₂ may be determined on the basis of the same algorithm for determining the split-decryption keys.

The above double split-key RSA cryptosystem may be generalized to a multiple split-key cryptosystem with k keys. To that end, instead of selecting d₁ and d₂ such that d₁*d₂=d (mod φ(n)), k−1 random (preferably different) integers which are coprime with φ(n) are determined and the final integer is computed as dₖ=(d₁* . . . *dₖ₋₁)⁻¹*d(mod φ(n)). RSA encryption and decryption algorithms E,D are commutative, so the keys may be generated in any desired order and the encryption and decryption operations may be performed in any desired order.

In another embodiment, a split-key cryptosystem may be based on the multiplicative homomorphic El Gamal (EG) cryptosystem. The EG scheme is based on the discrete logarithm problem rather than the factoring problem of RSA. In that case, encryption/decryption key pair e,d may be determined on the basis of the cipher algorithms:
Select a large prime number p and a generator g that generates the multiplicative group {0, 1, . . . , p−1} mod p;
Determine d by selecting a random number: d ∈{1, . . . , p−2};
Compute h=(g^{d})(mod p);
Determine public key e=(p,g,h).

Note that e is called “public” because it could be published without leaking secret information. In one embodiment, e would be published to enable third parties (e.g. users that generate and upload user-generated content) to encrypt content for the system, while the content source remains in fully control over the (partial) decryption steps. However, when there is no need to publish e, it is kept private.

Decryption key d and (public) encryption key e=(p, g, h)—wherein p, g, h are integers—may be stored as secret information for future use if necessary. In particular, the value p needs to be shared with the content distributor and the CCU, as these entities require p to perform their encryption and decryption operations. The value of p may be included in protocol messages exchanged during a content transaction between a content source and a CCU. In one embodiment, multiple transactions may use the same secret information. In that case, p would need to be communicated to the content distributor and a CCU only once.

A content item X may be processed on the basis of an agreed-upon reversible protocol known as a padding scheme, which turns X into an integer x wherein 0<x<p. If the process determines that X is too long, it may divide X in blocks that each satisfies the length requirement. Each block is thereafter separately processed in accordance with the padding scheme. Encryption algorithm Eₑ(X) for encrypting content item X into Xₑ may comprise the steps of:
select a random number s ∈ {1, . . . , p−2};
determining Xₑ=Eₑ(X,s)=(Y₁, Y₂)=((g^{s})(mod p), (X*h^{s})(mod p))

Similarly, a decryption operation D_{d}(Yᵢ,Y₂) for decrypting an encrypted content item Xₑ may be computed as:
D_{d}(Y₁,Y₂)=(Y₁^{-d}*Y₂)(mod p) (which indeed equals (g^{-ds}*h^{s} * X)(mod p)=X)

A split-key EG algorithm for determining a pair of split-decryption key d₁,d₂ may comprise the steps of:
determining d₁ to be a random number d₁ ∈ {1, . . . , p−2};
compute d₂=(d−d₁) mod p.

The above-described double split-key EG cryptosystem may be generalized to a multiple split-key cryptosystem using k split-encryption keys. To that end, instead of choosing d₁ and d₂ such that d₁+d₂=d mod p, k−1 random integers d₁ . . . dₖ₋₁ smaller than p may be selected and the final integer may be computed as dₖ=d−(d₁+ . . . +dₖ₋₁) (mod p).

A split-key EG algorithm for splitting the random encryption parameter s into/parts may be defined as follows:
The first party selects a random number s ∈ {1, . . . , p−2};
The first party chooses/random numbers sᵢ ∈ {1, . . . , p−2}, 1≦i≦i, such that s=(s₁+s₂+ . . . +sᵢ) mod p and sends s, to party i;
Let Y₁=(h^{s1}* X) mod p.
For i=1 to l−1 do
   Party i sends (g^{s} mod p, Yᵢ) to party i+1;
   Party i+1 performs its encryption step:
      Y₁ᵢ₊₁:=(h^{si}*Yᵢ) mod p.

It may be easily verified that (g^{s} mod p, Y₁)=Eₑ(X, s), because s=(s₁+s₂+ . . . +sᵢ) mod p. The different encryption steps are commutative.

A first decryption operation on the basis of decryption algorithm D and d₁ may be used to “partially” decrypt encrypted content Xₑ into X_{e,d1} by calculating D_{d1}(Xₑ) =D_{d1}(Y₁, Y₂)=(Y₁, Y₁^{-d1}*Y₂ (mod p)). Partially decrypted content X_{e,d1} is represented by a pair with the same first element Y₁. Since Y₁ is part of the encryption, it may be included in the protocol messages.

A second decryption operation on the basis of decryption algorithm D and d₂ may be used to determine the fully decrypted content by calculating X_{e,d1,d2}=D_{d2}(X_{e,d1}) wherein the second element of X_{e,d1,d2} will equal x: X_{e,d1,d2}=D_{d2}(X_{e,d1})=D_{d2}(D_{d1}(Y₁, Y₂))=(Y₁, Y₁^{-d2}*Y₁^{-d1}*Y₂)(mod p))=(Y₁, (Y₁^{-d}* Y₂) (mod p))=(Y₁, X). Original content item X may be determined from the calculated te^{p}d X_{e,d1,d2} by applying the padding scheme in reverse.

The EG decryption algorithm D is commutative, so the decryption keys can be generated in any desired order and the decryption operations may be performed in any desired order. Similarly, the encryption algorithm is also communicative, so encryption keys may be generated in any desired order and the encryption operations may be performed in any particular order.

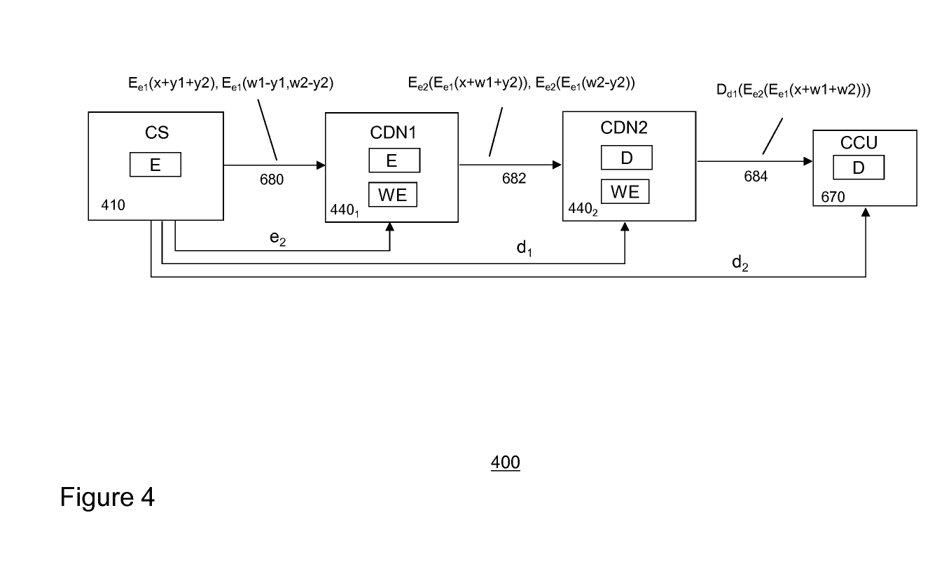

FIG. 4 depicts a schematic of a content delivery system comprising a homomorphic split-key cryptosystem implemented in a cascaded CDN network for delivering content to CCUs. In this particular example, the homomorphic split-key system may be configured to generate multiple split-encryption keys and split-decryption keys, e.g. θ₁, θ₂, d₁,

For example, in an embodiment, the content source 410 may generate a distorted content item X+y₁+y₂ by adding first distortion signal y₁ to a first part of the content item and second distortion signal y₂ to a second part of the content item and partially encrypt the distorted content item X+y₁+y₂ into a partially encrypted distorted content item Eₑ₁(X+yᵢ+y₂). Furthermore, the content source may generate a first compensating watermark payload w₁-y₁ on the basis of the first distortion signal y₁ and a second compensating watermark payload w₂-y₂ on the basis of the second distortion signal y₂ and partially encrypt the first and second compensating watermark payloads in first and second partially encrypted compensating watermark payloads Eₑ₁(w₁-y₁) and Eₑ₁(w₂-y₂) using a split-encryption key e₁. The first compensating watermark payload is configured such that the first distortion signal in the first part of the content item is removed when the first compensating watermark payload is embedded in the first part of the content item in the encrypted domain. The same holds for the second compensating watermarking payload.

The partially encrypted distorted content item and the partially encrypted first and second compensating watermark payload may be sent to a first CDN1 440₁, comprising a first watermark embedding module and an encryption unit. In some embodiments, these data may further include position information associated with distorted data units in the partially encrypted distorted content item. CDN1 may embed the partially encrypted first compensating watermark payload into the partially encrypted distorted content item Eₑ₁(X+y₁+y₂) using a homomorphic computation (an algebraic operation) in order to form a partially encrypted watermarked distorted content item Eₑ₁(X+w₁+y₂) comprising a first watermark associated with CDN1.

The encryption unit may be used to further encrypt the partially encrypted watermarked distorted content item Eₑ₁(X+w₁+y₂) on the basis of a further split-encryption key e₂ into encrypted watermarked distorted content item Eₑ₂(Eₑ₁(X+w₁+y₂)), before it is sent to a further, second CDN2. As the second CDN2 440₂ also may comprise a watermark embedding module, CDN1 440₁ may also encrypt the partially encrypted second compensating watermark payload Eₑ₁(w₂-y₂) in to (fully) encrypted second compensating watermark payload Eₑ₂(Eₑ₁(w₂-y₂)) and send this payload along with the encrypted watermarked distorted content item Eₑ₂(Eₑ₁(X+w₁+y₂)) 482 to the second CDN2.

The second CDN2 may comprise a second watermark embedding module which may embed the (partially) encrypted second compensating watermark payload in the (partially) encrypted watermarked distorted content item using a homomorphic computation so that a (partially) encrypted watermarked content item Eₑ₂(Eₑ₁(X+w₁+w₂)) is obtained wherein the first watermark payload w₁ forms a watermark associated with the first CDN1 and the second watermark payload w₂ forms a watermark associated with the second CDN2. A decryption unit in CDN2 may partially decrypt the encrypted watermarked content item Eₑ₂(Eₑ₁(X+w₁+w₂)) into a partially decrypted watermarked first content item D_{d1}(Eₑ₂(Eₑ₁(X−Fw₁+w₂))) 484, before it is sent to the CCU. The requesting CCU may comprise a decryption module and receive the second split-decryption key d₂ in order to fully decrypt the partially decrypted watermarked content item D_{d2}(D_{d1}(Eₑ₂(Eₑ₁(X+w₁+w₂))))=X+w₁+w₂.

This embodiment illustrates that the distortion signals may be used to force different CDNs to use predetermined compensating watermark payloads in order to watermark a content item. Furthermore, a distorted content item and compensating watermark payload may be sent in encrypted form to a first CDN1, may be processed and subsequently forwarded to a second CDN2, which uses the encrypted compensating watermark payload to watermark the content item in the encrypted domain. In one embodiment, a CDN may be configured to send and receive compensating watermark payload to and from other CDNs (in advance) over an inter-CDN interface. This interface may also be used by CDNs to exchange information on the watermarking and/or the (split-key) cryptosystem, including information on the type of encryption algorithm used, position information associated with the position of (partially) encrypted or decrypted perturbable data units in a content item, a seed for generating (split) encryption keys, a watermarking policy, etc.

It is submitted that may other variants are possible within leaving the scope of the invention. For example, the system in FIG. 4 may be implemented on the basis of a split-key cryptosystem wherein the content source is sending encrypted content to the first CDN1 comprising a decryption unit and wherein decryption of the encrypted content is performed on the basis of at least three consecutive decryption steps using at least three split-decryption keys d₁,d₂ and d₃. Furthermore, the system in FIG. 4 may be extended to a network of multiple CDN, which are configured to watermark and encrypt content items in accordance with the invention.

In the processes described above with reference to FIG. 1-4, in on embodiment, the (partially) decrypted watermarked content item may be sent to the CCU using a suitable streaming algorithm, e.g. an adaptive streaming algorithm, such as the HTTP adaptive streaming algorithm (HAS). In another embodiment, the (partially) decrypted watermarked content item may be recorded on a storage medium, e.g. an optical or magnetic storage medium, which may be delivered to the user of the CCU. In that case, the CCU may comprise a player for reading the content item from the storage medium.

In contrast with the known methods for delivering encrypted and watermarked content items, encrypting and watermarking encrypted content on the basis of a split-key cryptosystem allows secure watermarking of encrypted content in the encrypted domain. The whole sequence of decryption steps need to be executed before a fully decrypted content item X is generated so that during delivery the content item is always in the form of a cipher text. The sequence of decryption steps may be executed by different elements in the delivery chain such that only the last decryption step delivers the fully decrypted content item X.

Hence, a content source (such as a content provider) has to (partially) encrypt a content item only once using the encryption algorithm E and a (split-)encryption key before it is sent to the content distributor, which will store the (partially) encrypted content item and one or more perturbations for future use. Thereafter, during subsequent distribution of content items by the content distributor to requesting CCUs, the watermarking process (and some of the further crypto operations) are executed by the content distributor. This way, secure outsourcing of watermarking to a content distributor (an intermediate party) and the provisioning of differently (uniquely) encrypted and differently (uniquely) watermarked content items to a large number of different CCUs may be achieved. The outsourcing of the watermarking process to the content distributor allows substantial reduction of processing load of the content source and substantial reduction of data traffic between the content source and the content distributor.

Further details and embodiments associated with split-key cryptosystems and content delivery systems comprising such split-key cryptosystems are described in related European patent application with application number 11182553.5 with title “Secure distribution of content”, which is hereby incorporated by reference into this application.

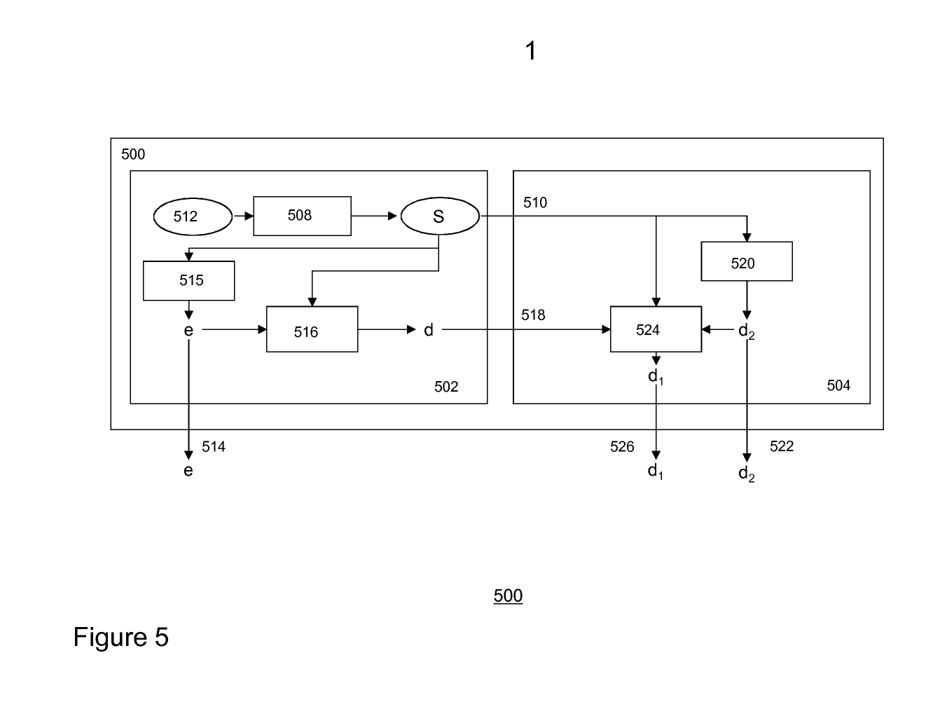

FIG. 5 depicts a schematic of a secret key generator for use in a split-key cryptosystem according to one embodiment of the invention. The secret key generator may comprise a cipher generator 502 for generating an encryption/decryption key pair e, d associated with cipher algorithms. In one embodiment, such cipher algorithms may comprise a predetermined (pseudo) random cipher algorithm 515, a predetermined deterministic cipher algorithm 516 and a split-key generator 504 for generating split-keys on the basis of at least one of the encryption or decryption keys e, d and predetermined random and deterministic split-key algorithms 520,506. The cipher generator and split-key generator may be configured to generate the keys required for a predetermined split-key cryptosystem, which will be described hereunder in more detail.

In the example of FIG. 5, the cipher generator may comprise a random generator 508 configured to generate random secret information S 510 on the basis of some configuration parameters 512, e.g. the length of encryption key(s), the length of decryption keys, the length of to-be-generated random numbers. Secret information S may be used for generating a random encryption key e 514 on the basis of a random key generator 515. A deterministic cipher algorithm 516 may use random encryption key e to generate decryption key d 518. In some embodiments, secret information S may be used to generate a random decryption key d, which may be used by a deterministic cipher algorithm to generate encryption key e.

Secret information S and decryption key d may be used by split-key generator 502 to generate split-keys, e.g. split-encryption keys and/or split-decryption keys. To that end, secret information S may be input to a random split-key generator 520 in order to generate a random split-decryption key d₂ 522. A deterministic split-key cipher algorithm 524 may generate a further split-decryption key d₁ 526on the basis of d and d₂.

In another embodiment, the split-key generator may be configured to generate on the basis of secret information S and d, k split decryption keys d₁,d₂, . . . , dₖ (k≧2). In a further embodiment, split-key generator may be configured to receive secret information S and encryption key e in order to generate i split encryption keys e₁,e₂, . . . , eᵢ (i≧2). In yet a further embodiment split-key generator may be configured to generate i split encryption keys and k split decryption keys d₁,d₂, . . . ,dₖ (i,k≧1 and i+k>2) on the basis of secret information S and encryption/decryption key pair e, d.

Table 1 provides an overview of key information and part of the secret information S, which needs to be distributed to the CS, the CD and the CCU for the different homomorphic cryptosystems. From this table, it follows that for the DJ cryptosystem not only the split-keys d₁ and d₂ but also part of the secret information S, i.e. n, are sent to the CD and the CCU respectively.

This information may be sent in a suitable “encryption container” to the entities in the content distribution system. In particular, it may use a so-called split-encryption control message (SECM) to send encryption information to a specific entity configured for (partially) encrypting a content item (e.g. an encryption module associated with the CS) and a split-decryption control message (SDCM) to send decryption information to as specific entity configured for (partially) decrypting a content item (e.g. a CDN of CCU decryption module).

TABLE 1
Overview of the information used by the encryption algorithm in the
CS and decryption algorithm in the CD and CCU.

| | | Key info | Key info |
|---|---|---|---|
| Cryptosystem | Key info S → CS | S → CD | S → CCU |
| Pallier | n, n1, r {n = p * q}r = | n, n2, r | p, q |
| | random integer of size n | | |
| Damgard- | p, q, g, d | n, d₁ | n, d₂ |
| Jurik | {n = p * q; h = g^{d} mod n, | | |
| | r = random integer of size n | | |
| RSA | p, q {n = p * q} | n, d₁ | n, d₂ |
| | e, d | | |
| ElGamal | p, g, d | p, d₁ | p, d₂ |
| | {h = g^{d} mod p}, s = | | |
| | random integer of size p | | |

As already shortly referred to above, selection of data units comprising a payload which are suitable for carrying a perturbation signal that is not perceptible when displayed, may depend on the protocol and/or codecs used for delivering content to the CCUs. For example, when an MPEG-type protocol is used, the consecutive pictures of a video are coded in I,P and B frames, wherein an I (intra) frame is an image which is processed on a spatial basis, wherein a P (predicted) frame is predicted from an I-frame or another P-frame and processed in a temporal way using a technique known as motion compensation; and, wherein an B (bi-directional) frame is not only predicted by its predecessor (like a P frame) but also by its successor.

Encoding of an I-frame consists of a number of consecutive steps, which are well-known in the art. First a video filter transforms RGB pixels represented by bit values, e.g. an 8-bit value, for each primary colour to an YCbCr presentation where Y is the luminance signal. A Discrete Cosine Transform (DCT) transforms a block, e.g. an 8 by 8 or a 16 by 16 block, of pixels to a block of weighting values, e.g. 12-bit weighting values, similar to the discrete Fourier transform. The first weighting value, called the DC value, corresponds to a solid luminance or colour value for the entire block and the remaining lower frequency DCT coefficients correspond to smoother spatial contours.

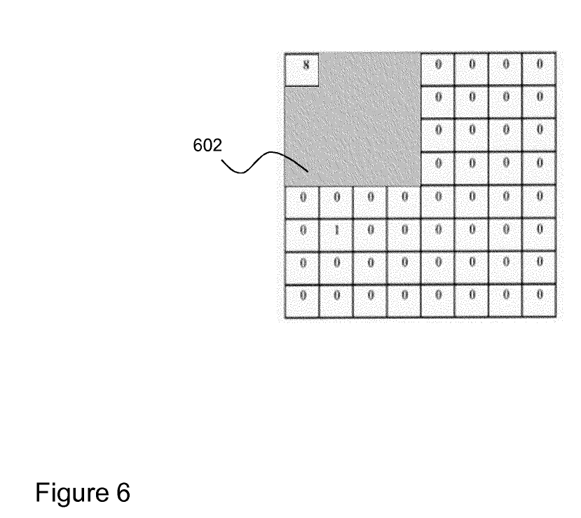

Each DCT value is quantized (compressed) by dividing it by a quantization value and rounding the result to the nearest integer. After quantization many DCT values, especially the ones corresponding to high frequencies, will be zero, which allows for further efficiency in the coding. For example, run-length variable length coding (VLC) may be used to encode likely (small) coefficient values by a small number of bits. Encoding of the P and B frames is a little more complicated but also results in a matrix of DCT coefficients, e.g. a 8 by 8 matrix of DCT coefficients 600, as depicted in FIG. 6. In this embodiment, the low-frequency coefficients are located in the top-left corner and the high-frequency coefficients are located in the bottom right corner.

A suitable location for inserting watermarks in (encrypted) MPEG encoded videos may be one or more low frequency DCT coefficients (excluding the first so-called DC value) of the I frames. In an embodiment, one or more of the 14 low frequency DCT coefficients 602 (indicated in gray in FIG. 6) may be selected for adding a watermark signal. In another embodiment, one or more of the 28 low frequency DCT coefficients may be used. These coefficient values are sufficiently high to be slightly modified without being noticed when displayed; and, the biggest compression gain through run-length VLC is in the remaining high-frequency DCT values (for this reason the B and P frames are less suitable).

Hence, from the above it follows that, in one embodiment, one or more predetermined (low frequency) DCT coefficients associated with an MPEG frame, preferably an I-frame, may be identified during the processing of the content item as one or more perturbable data units. The positions of these low frequency coefficients in the content item may be sent as watermarking position information to the content distributor. Similarly, the one or more low frequency DCT coefficients in a coded content item may be used for insertion of a distortion signal in order to generate a distorted content item. Such scheme may be implemented in combination with any suitable embodiment described in this disclosure.

In the embodiments of FIG. 1-5, the content source may encode and compress a plaintext content item of e.g. a raw video data format into an encoded and compressed content item, e.g. an MPEG movie, and encrypt it so that it can be securely send to the content distributor, which may embed a watermark in the content item in the encrypted domain and so that the consumer is able to decrypt the encrypted content item and obtain a watermarked content item.

Further, the content source may comprise a content processor for processing the content before it is ingested by the content distributor. The content processor may be similar to the content processor as described in detail with reference to FIG. 1A-1C.

The use of homomorphic cryptosystem such as the DJ split-key cryptosystem or the Pallier cryptosystem may cause a factor of two in the amount of data transmitted (as e.g. 1024 bit plaintext is encrypted into a 2048 bit cipher text). However, the homomorphic encryption is in principle only required for the distorted data units x-y, i.e. the data units that are designated to be watermarked in the encrypted domain.

Hence, in some embodiments, the content source may split a content item X in a common, non-distorted content item X₁ comprising data units and a to-be-distorted content item X₂ comprising perturbable data units which are distorted by the content processor on the basis of distortion signal y. In that case, common content item X₁ may be encrypted on the basis of a fast and efficient (symmetric) cryptosystem, e.g. EAS or a stream cipher, and the distorted content item X₂ may be encrypted using a homomorphic cryptosystem. Thus, in this embodiment, only the part of the content item comprising distorted data units is encrypted in accordance with an additive homomorphic cryptosystem. The other parts of the content item may be encrypted using another cryptosystem, e.g. AES or a stream cipher. This way data traffic between the entities in the content delivery system may be substantially reduced.

FIG. 7 depicts a schematic overview of a content delivery system according to an embodiment of the invention. In this particular embodiment, the content item is split in a common (non-distorted) content part and a to-be-watermarked content part. In particular, FIG. 7 depicts a content source 710, a content distributor 740 and a CCU 770 which may be implement in accordance to any of the embodiments as described with reference to FIG. 1-5 above. Further, the content source may comprise a content splitting unit (CSU) 772 for splitting content item X 721 into a common content item X₁ 712₁ and a perturbable content item X₂ 712₂. In an embodiment, the content splitting unit may be part of the processing function 724 of or associated with the content source.

Hence, in this embodiment, the content source may pre-process the content item X in order generate position information 726 associated with perturbable data units. Further, on the basis of the position information, the content splitting unit may split the content in a common content item X₁ and a perturbable content item X₂. Examples of encoded perturbable data units may include DCT coefficients in MPEG2-encoded video or IPCM frames in an H.264-encoded video as used with HD DVD, Blu-ray Discs, and (internet) streaming. Some embodiments associated with encoded perturbable data units will be discussed hereunder in more detail.

The content source may distribute the common content item X₁ via the content distributor to the consumer. The common content item X₁ may be encrypted by a first encryption unit 780 comprising a first encryption algorithm E₁. The first encryption algorithm may be part of a first cryptosystem comprising an efficient and fast first encryption and decryption algorithms E₁,D₁ (e.g. the well-known Advanced Encryption Standard (AES) or a derivative thereof or a symmetric stream cipher). The encrypted common content item E₁(X₁) may be distributed via the content distributor in encrypted form to the CCU. In the CCU, a decryption unit 782 (associated with encryption unit 780) may subsequently decrypt the common content item into a plain text common content item X₁. The perturbable content item X₂ may be distorted, encrypted, watermarked, distributed and decrypted (by the CCU) into a fully decrypted watermarked content item X₂+w using a second homomorphic cryptosystem comprising second encryption and decryption algorithms E₂,D₂ as described with reference to any of the embodiments described with reference to FIG. 2-4.

A content combiner (CC) 772 in the CCU may subsequently combine the watermarked content item X₂+w and common content item X₁ into a watermarked content item X+w 774. Hence, this particular embodiment provides the advantage that a large part of the content item is encrypted and distributed in accordance with an efficient cryptosystem, which does not increase the traffic between the content source, content distributor and CCUs. Only a relative small part (e.g. 1 Mb of a 1 Gb video file) is distorted, encrypted and watermarked using a homomorphic split-key cryptosystem so that the data traffic between the content source and content distributor is reduced.

Although FIG. 7 is described as a content delivery system comprising a content distributor, the splitting of the content into a common part and a distorted part may also be implemented in a content delivery system without a separate (third party) content delivery system as described with reference to FIG. 1.

Selection of data units suitable for carrying part of a watermark, a perturbation, may depend on the data compression scheme, which is used to compress the raw video data file or stream into a compressed video file or stream. For example, when a content item is compressed in accordance with an MPEG-based standard such as MPEG 2 or H.264, the consecutive pictures of a video are coded in I,P and B frames, wherein an I (intra) frame is an image which is processed on a spatial basis, wherein a P (predicted) frame is predicted from an I-frame or another P-frame and processed in a temporal way using a technique known as motion compensation; and, wherein an B (bi-directional) frame is not only predicted by its predecessor (like a P frame) but also by its successor.

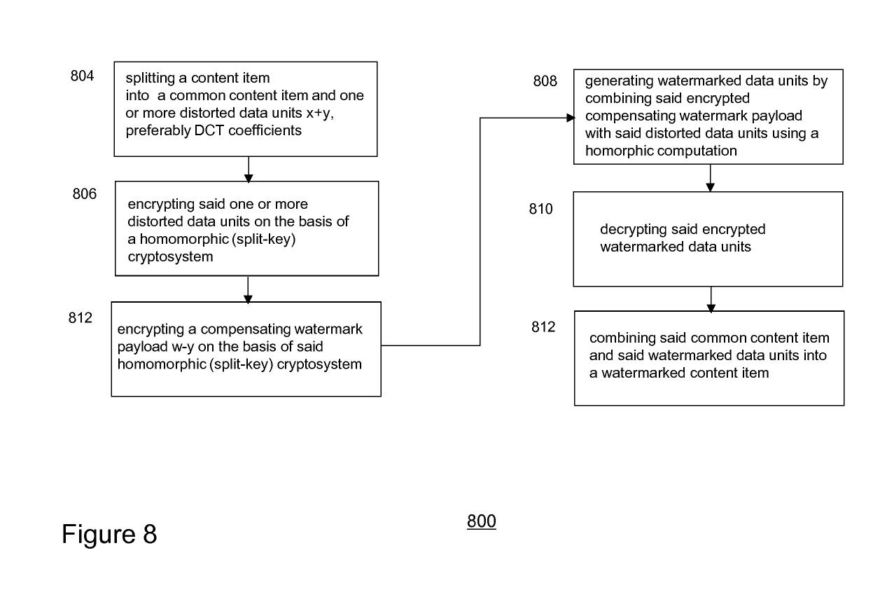

FIG. 8 depicts a process flow associated with the process of delivering a compressed encrypted watermarked content item according to an embodiment of the invention. The process may start with coding the content item in a compressed content item (step 802), for example raw video data of a movie comprising a sequence of video frames into a predetermined coding format. In one embodiment, the coding format may comprise I,P and B frames according to the MPEG standard. Further a video filter may be applied to the frames in order to change the RGB coding into an associated YCbCr coding. Moreover, a DCT coding may be applied in order to transform pixel blocks of a predetermined size (e.g. 8 by 8 blocks of pixels) to a block of DCT coefficients whereby each coefficient is scaled (quantized) according to an appropriate value.

Thereafter, in a further step 804, the content splitting unit of the content source (as explained with reference to FIG. 7) may split the DCT coded content item into a common content item X₁ and a perturbable content item X₂ comprising a predetermined number of perturbable data units. In one embodiment, the perturbable data units may relate to one or more DCT coefficients of different DCT blocks. When the content splitter of the content source has identified the perturbable data units (i.e. the perturbable DCT coefficients x,), distortion information y, may be added to the perturbable data units thus forming a distorted data unit x,+y, (in this case distorted DCT coefficients).

These distorted DCT coefficients, which may be structured in a data structure (hereafter referred to as a distorted watermarking (W) block), are not run-length encoded using VLC. Optionally, in an embodiment, the remaining part, the common content item (comprising the quantized DCT coefficients of P- and B-frames and the quantized DCT coefficients of the I-frames that are not part of the W-block) may be further compressed. For example, in one embodiment, using e.g. a run-length encoding scheme.

The split content items may then encrypted and delivered to the CCU in a similar way as described with reference to FIG. 7: the compressed common content item may be encrypted in accordance with a fast cryptosystem, e.g. AES or a stream cipher, and the distorted DCT coefficients in the W-block may be encrypted using a homomorphic (split-key) cryptosystem (step 806). For example, when using the DJ split-key cryptosystem, each distorted DCT coefficient x,+y, may be encrypted into an encrypted distorted DCT coefficient Eₑ(xᵢ+yᵢ, rᵢ,) wherein x, is the i-th quantized DCT coefficient, yᵢ is the distortion signal for the i-th coefficient and rᵢ is the random number for the i-th coefficient used by the DJ encryption algorithm. The content source may send the encrypted distorted DCT coefficients (as an encrypted distorted W-block) to the content distributor together with the DJ public key e=(n, g, h).

Then, when a consumer would like to buy the content item X from the content source, the content source may generate two DJ split-decryption keys d₁ and d₂ wherein the first split-decryption key is provided to the content distributor and the second split key is provided together with the DJ public key to the CCU of the consumer. Further, the content source may then generate an identifier, e.g. content identifier, and—on the basis of the identifier a compensating watermark payload wᵢ-y,. The content source may encrypt the compensating watermark payload wᵣ-yᵢ into an encrypted compensating watermark payload Eₑ(wᵢ-yᵢ) (step 808) on the basis of the DJ crypto-cipher and the DJ public key e=(n, g, h). When an encrypted compensating watermark payload is combined with its associated encrypted distorted DCT coefficient, the distortion information is compensated (cancelled) while a watermarking signal δ is introduced into the DCT coefficient. The encrypted compensating perturbations are subsequently sent to the content distributor.

The embedding function in the content distributor may subsequently combine (add) the encrypted compensating payload Eₑ(wᵢ-yᵢ) with (to) the encrypted distorted DCT coefficients in the W-block using an homomorphic computation (step 810). Here a homomorphic multiplication of the encrypted distorted DCT coefficients and compensating watermark payload may be used: {Eₑ(xᵢ+yᵢ)* Eₑ(wᵢ-yᵢ)} mod n²=Eₑ(xᵢ+wᵢ). Hence, this way, the distortion signals may be removed from the distorted DCT coefficients and a watermark signals δ may be added to the DCT coefficients. The watermark signals may form a watermark that is embedded in the content item.

Further, the thus encrypted watermarked DCT coefficients (forming an encrypted watermarked W-block) may be partially decrypted on the basis of a first DJ split-key d₁. The content distributor may then send the two encrypted content items, the encrypted common content item and the partially decrypted watermarked DTC coefficients in the W-block, to the CCU, which may fully decrypt the partially decrypted watermarked DCT coefficients in the W-block on the basis of a second split-decryption key d₂ (step 812) and decrypt the common content item on the basis of a suitable decryption key.

Thereafter, a content combiner in the CCU may combine the watermarked DCT coefficients with the plaintext common content item into a non-compressed plaintext watermarked content item (step 812).

Alternatively, in one embodiment, the CCU may generate a watermarked compressed MPEG movie. To that end, the content combiner in the CCU may for each DCT-coefficient in the W-block perform the steps of: decode the run-length encoded VLC blocks of the common content item into DCT blocks; insert the watermarked DCT coefficients; and, recode the complete set of DCT blocks by run-length encoding into a watermarked and compressed content item so that the CCU is able to play it using a suitable video player, e.g. an MPEG player.

FIG. 9 depicts a schematic of at least part of a manifest file 900 according to one embodiment of the invention. In particular, FIG. 9 depicts at least part of a manifest file (in this example part of an MPEG-DASH MPD) comprising watermarking position information, which may be used by the watermarking embedder in the client.

The manifest file may comprise further information. For example, the manifest file may comprises a manifest type indicator 902 for indicating whether the manifest file is a “static” manifest file, which does not change in time, or a dynamic manifest file, which may change in time. For example, in an embodiment, the client may receive at predetermined times, e.g. periodically, a new updated manifest file or an manifest file update for updating the manifest file in the client, comprising newly updated information associated with the streaming path. The manifest file may further comprise a buffer parameter “minBufferTime” 904 for the play-out buffer in the HAS client. This buffer parameter may define a minimum size for the play-out buffer before data in the play-out buffer may be played-out.

The manifest file may further comprise location information 906,908 for locating one or more segments in the network. The location information may e.g. comprise (part of) an URL 906 of a segmented content file cdn.example.com/movie_{—}480x208.mp4. The segmented content file may comprise a number of segments, which in this example are defined as a bitrange within the segmented content file. The parameter “mediaRange” 910 may be used to define the bitrange. In another embodiment (not shown) each segment of the segmented content file may be defined in the manifest file by a separate URL. In order to localize encrypted distorted data units (or an encrypted distorted block) in a segment, watermark bitrange information may be used in order to define a bitrange (a set of bits) within the bitrange defining a segment that comprises the distorted data units. The bitrange information may be defined using the bitrange parameter “watermarkRange” 912.

Hence, in the example of FIG. 9, a first segment may be defined by bits 4144-293772 of the segmented content file, wherein bits 4144-6192 may define a block of encrypted distorted data units. This way, the manifest file in FIG. 9 may indicate that (in this example) the first, fourth and sixth segment comprise distorted data units in a particular part of the segment file. The watermark bitrange information in the manifest file may thus be used as part of the watermarking position information for the watermark embedder in the receiver. The watermark embedder may use the watermark bitrange information to localize the encrypted distorted data units in an encrypted segment and to combine the encrypted distorted data units with an associated encrypted compensating watermark signal as described in detail with reference to FIG. 1A-1C.

The manifest file may comprise further information for the receiver. In an embodiment, the manifest file may further comprise (at least part of) the encrypted compensating watermark signals. In another embodiment, the manifest file may comprise a parameter for indicating the type of homomorphic encryption the watermarking system is using. In yet another embodiment, the manifest file may comprise a parameter for indicating the block size N used by the homomorphic cryptosystem.

It is submitted that the embodiments in FIG. 1-9 are merely non-limiting examples for illustrating the advantages of the invention. For example, in the content delivery systems described with reference to FIG. 2-4, the content distributor instead of the content source may encrypt the compensating watermark payload w-y. To that end, the content distributor may comprise an encryption unit in order to encrypt the compensating watermark payload on the basis of an encryption key (public key) originating from the key generator before it is combined with the encrypted distorted content item. Further, although FIG. 8 is described with reference to a homomorphic split-key cryptosystem, other homomorphic cryptosystem as described with reference to FIG. 1-4 may be used to. Moreover, a split-key cryptosystem may allow splitting of a decryption key in more than two split-decryption keys, so that it is also particular suitable in situations where content is distributed via a network of CDNs, e.g. a first CDN1 and a second CDN2, wherein each CDN comprises an encryption unit and an embedding function such that each of these CDNs are capable of watermarking and partially decrypting encrypted content items.

The units and modules described in this application may be implemented as dedicated hardware units or modules, a (secure) software program or a combination thereof.

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. The invention is not limited to the embodiments described above, which may be varied within the scope of the accompanying claims.

1. A method for secure watermarking of at least part of a content item X, the method comprising:
at a content source, providing a distorted content item X+y, comprising one or more distorted data units, wherein a payload of a distorted data unit comprises one or more distortion signals yᵢ which distort a rendering of the distorted data unit;
providing a compensating watermark payload w-y comprising one or more compensating watermark signals δᵢ−yᵢ;
using homomorphic encryption for encrypting at least part of the distorted content item X+y into an encrypted distorted content item E(X+y) and for encrypting at least part of the compensating watermark payload into an encrypted compensating watermark payload E(w-y) on a basis of one or more encryption keys;
obtaining an encrypted watermarked content item by combining at least part of the encrypted distorted content item comprising the one or more distorted data units with at least part of the encrypted compensating watermark payload on a basis of one or more homomorphic computations, wherein the one or more homomorphic computations modify the distortion signal y in the payload of the distorted data unit into a watermark signal δ; and
transmitting the encrypted distorted content item E(X+y) and the encrypted compensating watermark payload E(w-y) to a content receiving entity.

2. The method according to claim 1 wherein providing the distorted content item may comprise providing distortion position information, the distorting position information comprising: information for identifying the position of distorted data units in the distorted content item, information for identifying which of the distorted data units are perturbable, wherein a perturbable data unit comprises a payload that is suitable for receiving one or more watermark signals δᵢ; and/or, information for identifying a predetermined distortion signal yᵢ that is added to a distorted data unit at a predetermined position in said distorted content item.

3. The method according to claim 2 further comprising:
providing watermarking position information on the basis of the distortion position information, the watermarking position information being at least one of information for identifying compensating watermark signals in the encrypted compensating watermark payload or information for relating at least one of the compensating watermark signal to a position of a distorted data unit in said encrypted distorted content item.

4. The method according to claim 2 wherein providing the compensating watermark payload comprises:
generating a watermark payload w on the basis of an identifier, the watermark payload comprising one or more watermark signals δᵢ;
providing the compensating watermark payload w-y on the basis of the watermark payload w, the one or more distortion signals yᵢ and the distortion position information.

5. The method according to claim 1, wherein the content receiving entity is a content consumption unit, and wherein the method further comprises:
the content consumption unit receiving the encrypted distorted content item E(X+y) and the encrypted compensating watermark payload E(w-y) from the content source;
a watermark embedder in the content consumption unit combining at least part of the encrypted distorted content item with at least part of the encrypted compensating watermark payload on the basis of one or more homomorphic computations into an encrypted watermarked content item E(X+w); and
a decryption unit in the content consumption unit decrypting the encrypted watermarked content item into a watermarked content item on the basis of at least one decryption key d.

6. The method according to claim 1, wherein the content receiving entity is a content distributor, and wherein the method further comprises:
the content distributor receiving the encrypted distorted content item E(X+y) and the encrypted compensating watermark payload E(w-y) from a content source; and
a watermark embedder in the content distributor combining at least part of the encrypted distorted content item with at least part of the encrypted compensating watermark payload on the basis of one or more homomorphic computations into an encrypted watermarked content item E(X+w).

7. The method Method according to any of claim 1, wherein the homomorphic encryption is based on an homomorphic cryptosystem comprising at least one encryption algorithm E, at least one decryption algorithm D and a key generator for generating at least an encryption key e and a decryption key d for use with the encryption algorithm D and decryption algorithm E respectively, the homomorphic cryptosystem being based on the RSA, the El Gamal, the Damgard-Jurik or the Pallier encryption and decryption algorithms.

8. The method according to claim 5, wherein the homomorphic encryption is based on a split-key cryptosystem comprising encryption and decryption algorithms E and D, a key generation algorithm for generating encryption and decryption keys e,d, a split-key algorithm for splitting e into i different split-encryption keys e₁,e₂, . . . , eᵢ and for splitting d into k different split-decryption keys d₁,d₂, . . . , dₖ respectively wherein i,k≧1 and i+k>2; wherein when using the split-key cryptosystem executing i consecutive encryption operations and k consecutive decryption operations on content item X using the split-encryption and split-decryption keys respectively, generates a fully decrypted content item X: D_{dk}(D_{dk-1}( . . . (D_{d2}(D_{d1}(Eₑᵢ(Eₑᵢ₋₁( . . . (Eₑ₂(Eₑ₁(X)) . . .))=X.

9. The method according to claim 8 wherein the split-key cryptosystem is based on the homomorphic Damgard-Jurik (DJ) encryption and decryption algorithms, and wherein the method further comprises:
determining an integer d₂ to be a random number d₂ ∈ {0, . . . , n−1} wherein n is the modulus of the DJ system; and
determining d₁ by calculating (d−d₂) mod n.

10. The method according to claim 1, wherein combining the at least part of the encrypted distorted content item with the at least part of the encrypted compensating watermark payload is performed by a first content delivery network; and wherein providing distorted content item X+y is performed by a content source.

11. The method according to claim 1, further comprising delivery of at least part of the content item, wherein delivery of the at least part of the content item comprises:
sending at least part of the encrypted watermarked content item from a first content distribution network (CDN1) to a second content distribution network (CDN2), wherein the first and second content distribution networks comprise at least an encryption unit comprising a homomorphic encryption algorithm or a decryption unit comprising an homomorphic decryption algorithm, the homomorphic encryption and decryption unit being associated with a homomorphic cryptosystem; and wherein at least one of the first or second content delivery network comprise at least a watermark embedder for forming an encrypted watermarked content item by combining at least part of the homomorphic encrypted distorted content item with at least part of the homomorphic encrypted compensating watermark payload on the basis of one or more homomorphic computations.

12. The method according to claim 11 wherein the first CDN and second CDN are configured to communicate over an interface, and the method further comprises:
the first CDN sending watermarking information over the interface to the second CDN, wherein the watermarking information comprises: at least part of an (encrypted) compensating watermark payload, watermarking position information for identifying the positions of one or more distorted data units in a distorted content item, information on the type of cryptosystem used, a seed for generating one or more encryption keys and a watermarking policy.

13. A content source device configured for enabling secure watermarking of a content item X comprising:
a content processor for generating distorted content item X+y on the basis of at least part of the content item X and one or more distortion signals y, the distorted content item comprising one or more distorted data units wherein the payload of a distorted data unit comprises a distortion signal y which distorts the rendering of the payload in the distorted data unit;
a watermark generator configured for generating a compensating watermark payload w-y comprising one or more compensating watermark signals δ−y;
an encryption unit configured for homomorphic encryption for encrypting at least part of the distorted content item X+y and for encrypting at least part of the compensating watermark payload into an encrypted distorted content item E(X+y) and an encrypted compensating watermark payload E(w-y) on the basis of one or more encryption keys; and,
a transmitter configured for sending the encrypted distorted content item and the encrypted compensating watermark payload to a watermark embedder configured for combining the encrypted distorted content item with said encrypted compensating watermark payload on the basis of one or more homomorphic computations, wherein the one or more computations modify a distortion signal y in the payload of a distorted data unit into a watermark signal δ.

14. A content processing device for watermarking a content item X, the content processing device comprising:
a data receiver for receiving at least part of an encrypted distorted content item, the distorted content item comprising one or more distorted data units wherein the payload of a distorted data unit comprises a distortion signal y which distorts the rendering of the payload in distorted data unit; and for receiving a compensating watermark payload w-y comprising one or more compensating watermark signals δ−y; wherein the distorted content item and the compensating watermark payload are encrypted using a homomorphic encryption algorithm;
a watermark embedder for forming an encrypted watermarked content item by combining the encrypted distorted content item with the encrypted compensating watermark payload on the basis of one or more homomorphic computations, wherein the one or more computations modify a distortion signal y in the payload of a distorted data unit into a watermark signal δ.

15. (canceled)

16. A non-transitory computer-readable medium having instructions stored thereon that, when executed by one or more processors of a system, cause the system to carry out operations including:
providing a distorted content item X+y, comprising one or more distorted data units, wherein a payload of a distorted data unit comprises one or more distortion signals yᵢ which distort a rendering of the distorted data unit;
providing a compensating watermark payload w-y comprising one or more compensating watermark signals δᵢ−yᵢ;
using homomorphic encryption for encrypting at least part of the distorted content item X+y into an encrypted distorted content item E(X+y) and for encrypting at least part of the compensating watermark payload into an encrypted compensating watermark payload E(w-y) on a basis of one or more encryption keys;
obtaining an encrypted watermarked content item by combining at least part of the encrypted distorted content item comprising the one or more distorted data units with at least part of the encrypted compensating watermark payload on a basis of one or more homomorphic computations, wherein the one or more homomorphic computations modify the distortion signal y in the payload of the distorted data unit into a watermark signal δ; and
transmitting the encrypted distorted content item E(X+y) and the encrypted compensating watermark payload E(w-y) to a content receiving entity.

17. The method of claim 8, wherein the split-key cryptosystem is based on the homomorphic RSA encryption and decryption algorithms, and wherein the method further comprises:
determining an integer d₁ to be a random number 1<d₁<®(n), wherein d₁ and tp(n) are coprime, n is the modulus of the RSJ system, and tp(n) is Euler's totient function; and
determining d₂=d₁⁻¹*d (mod φ(n)).

18. The method of claim 8, wherein split-key cryptosystem is based on the homomorphic ElGamal encryption and decryption algorithms, and wherein the method further comprises:
determining an integer d₁ to be a random number d₁ ∈ {1, . . . , p−2}; and
determine d₂=(d−d₁) mod p.
